(19) United States
(12) Patent Application Publication
(10) Pub. No.: US 2024/0378549 A1
(43) Pub. Date: Nov. 14, 2024

(54) DELIVERY CONTROL APPARATUS, DELIVERY PERSON TERMINAL AND ADDRESSEE TERMINAL

(71) Applicant: NEC Corporation, Minato-ku, Tokyo (JP)

(72) Inventors: Kohei SUGA, Tokyo (JP); Daisuke KAWASAKI, Tokyo (JP); Kaori YAMANE, Tokyo (JP)

(73) Assignee: NEC Corporation, Minato-ku, Tokyo (JP)

(21) Appl. No.: 18/689,538

(22) PCT Filed: Sep. 16, 2021
(86) PCT No.: PCT/JP2021/034065

§ 371 Date: Mar. 6, 2024

(51) Int. Cl. G06Q 10/0836

(52) U.S. Cl. CPC G06Q 10/0836

(57) ABSTRACT

A delivery control apparatus (101) includes a delivery request acquisition unit (109) that acquires, from an addressee terminal, a delivery request including first identification information for identifying a package, a responsibility request unit (110) that transmits a responsibility request for delivery of the package to a delivery person terminal, a first authentication unit (111) that performs biometric authentication of a delivery person, based on biometric information acquired from the delivery person terminal of the delivery person who responds to the responsibility request, and a responsibility notification unit (113) that transmits, to the delivery person terminal, second identification information for proving that the delivery person is a person in charge of delivery of the package, when the biometric authentication of the delivery person has succeeded.

### TECHNICAL FIELD

The present invention relates to a delivery control apparatus, a delivery person terminal, an addressee terminal, a package control system, a delivery control system, a delivery control method, a responsibility determination method, a package reception method, a package control method, and a program.

### BACKGROUND ART

For example, Patent Document 1 describes a delivery request system in which a plurality of users P1 and P2 mutually request and are entrusted with delivery of an article by use of an information processing terminal such as a smartphone. The delivery desiring user P1 specifies an article that he/she desires to possess, and requests delivery thereof to a place where he/she can receive. The delivery entrustment user P2 expresses intention of consenting to receive a request for delivery, and carry out the delivery, according to the desire for the delivery of the article.

Patent Document 1 describes an example in which the delivery desiring user P1 residing in country A (e.g., Vietnam) requests the delivery entrustment user P2 residing in country B (e.g., Japan) for delivery. The delivery entrustment user P2 carries out delivery entrustment work according to, for example, a personal schedule of travel.

The delivery request system described in Patent Document 1 includes an information processing server with a request condition display unit that processes each piece of information constituting a delivery request condition into a searchable state and displays the information to a delivery entrustment user who desires to be entrusted with delivery work.

### Related Document

### Patent Document

Patent Document 1: Japanese Patent Application Publication No. 2021-006985

### DISCLOSURE OF THE INVENTION

### Technical Problem

In a general home delivery service, a time period for delivery may be able to be specified in order for an addressee to easily receive a package. However, even when a time period for delivery is specified in a delivery request condition described in Patent Document 1, a time period being able to be specified often has a time span of about 2 to 3 hours, and the addressee needs to wait at home or the like being a destination of the package during the specified time period.

Moreover, in a general home delivery service, an addressee may be able to specify a reception place where a package is easily received. As the reception place, for example, a convenience store, a delivery center, or the like near a home of the addressee is often specified. The delivery center is a base for performing delivery and transportation within an area determined by a home delivery company.

A package is kept at a reception place, and, thereby, an addressee is able to visit the reception place at a convenient time and receive the package. Moreover, a package is able to be checked at the reception place, and, thereby, a home delivery company is able to reduce a trouble of re-delivering the package. Thereby, convenience relating to reception of a package is able to be improved to some extent.

However, even when a reception place is specified, it takes a trouble for an addressee to go to the reception place to receive a package. Moreover, it may be difficult for an addressee to go to a reception place to receive a package. When an addressee is not able to go to a reception place to receive a package within a previously determined period, the package is often returned to a sender.

Herein, in order for a package to be delivered from a reception place to a delivery place where an addressee is present, it is considered to utilize a delivery request system described in Patent Document 1 by assuming an addressee of the package to be a delivery desiring user P1, and assuming a delivery person to be a delivery entrustment user P2.

In this case, since a delivery person needs to accept the package at the reception place, it is considered that information for determining a package that has been kept at the reception place is set in the delivery request condition. Then, it is considered that the delivery entrustment user P2 views the delivery request condition displayed by a request condition display unit and is entrusted with a request for delivery being able to satisfy the delivery request condition.

However, in the delivery request system described in Patent Document 1, there is a possibility that not only the entrusted delivery entrustment user P2 but anyone viewing the delivery request condition, such as another delivery entrustment user P2, is able to receive, at a reception place, a package determined by the delivery request condition. Thus, there is a risk of a theft of a package, or the like, and there is a possibility of impairing reliability for safely and certainly sending a package to a delivery destination.

The present invention has been made in view of circumstances described above, and one of objects thereof is to improve convenience relating to reception of a package. Moreover, one of the objects according to the present invention is to make an improvement in reliability of delivery.

### Solution to Problem

In order to achieve the above object, a delivery control apparatus according to a first aspect of the present invention includes:
a delivery request acquisition unit that acquires, from an addressee terminal, a delivery request including first identification information for identifying a package;
a responsibility request unit that transmits a responsibility request for delivery of the package to a delivery person terminal;
a delivery person authentication unit that performs biometric authentication of a delivery person, based on biometric information acquired from the delivery person terminal of the delivery person who responds to the responsibility request; and a responsibility notification unit that transmits, to the delivery person terminal, second identification information for proving that the delivery person is a person in charge of delivery of the package, when the biometric authentication of the delivery person has succeeded.

In order to achieve the above object, a delivery person terminal according to a second aspect of the present invention includes:
a responsibility request acquisition unit that acquires a responsibility request for delivery of a package;
a generation unit that generates biometric information of a delivery person who responds to the responsibility request; and
a responsibility notification acquisition unit that acquires second identification information for proving that the delivery person is a person in charge of delivery of the package, when biometric authentication based on biometric information of the delivery person has succeeded.

In order to achieve the above object, an addressee terminal according to a third aspect of the present invention includes:
a second generation unit that generates biometric information of an addressee upon acquiring trigger information for starting biometric authentication of the addressee when the addressee receives a package; and
a reception processing unit that executes biometric authentication of the addressee, based on the biometric information, or transmits the biometric information to a delivery control apparatus for controlling delivery of the package.

In order to achieve the above object, a package control system according to a fourth aspect of the present invention is
a package control system including a package control terminal installed at a reception place of a package, and the package control system includes:
a second identification information acquisition unit that acquires, from a delivery person terminal, second identification information for proving that a delivery person is a person in charge of delivery of the package; and
a first communication unit that mutually communicates with a delivery control apparatus for controlling delivery of the package, wherein
the first communication unit transmits the second identification information to the delivery control apparatus when the second identification information is acquired by the second identification information acquisition unit.

In order to achieve the above object, a delivery control system according to a fifth aspect of the present invention includes:
an addressee terminal owned by an addressee of a package delivered to a reception place;
a delivery control apparatus for controlling delivery of the package in response to a delivery request from the addressee; and
a delivery person terminal owned by a delivery person of the package, wherein
the addressee terminal includes
   a delivery request unit that transmits a delivery request including first identification information for identifying the package,
the delivery control apparatus includes
   a delivery request acquisition unit that acquires the delivery request from the addressee terminal,
   a responsibility request unit that transmits a responsibility request for delivery of the package to the delivery person terminal,
   a delivery person authentication unit that performs biometric authentication of a delivery person, based on biometric information of the delivery person acquired from the delivery person terminal of the delivery person who responds to the responsibility request, and
   a responsibility notification unit that transmits, to the delivery person terminal, second identification information for proving that the delivery person is a person in charge of delivery of the package, when biometric authentication of the delivery person has succeeded, and
the delivery person terminal includes
   a responsibility request acquisition unit that acquires the responsibility request,
   a generation unit that generates biometric information of the delivery person who responds to the responsibility request, and
   a responsibility notification acquisition unit that acquires the second identification information from the delivery control apparatus, when biometric authentication of the delivery person has succeeded.

In order to achieve the above object, a delivery control method according to a sixth aspect of the present invention includes,
by a computer:
acquiring, from an addressee terminal, a delivery request including first identification information for identifying a package;
transmitting a responsibility request for delivery of the package to a delivery person terminal;
performing biometric authentication of a delivery person, based on biometric information acquired from the delivery person terminal of the delivery person who responds to the responsibility request; and
transmitting, to the delivery person terminal, second identification information for proving that the delivery person is a person in charge of delivery of the package, when the biometric authentication of the delivery person has succeeded.

In order to achieve the above object, a responsibility determination method according to a seventh aspect of the present invention includes,
by a computer:
acquiring a responsibility request for delivery of a package;
generating biometric information of a delivery person who responds to the responsibility request; and
acquiring second identification information for proving that the delivery person is a person in charge of delivery of the package, when biometric authentication based on biometric information of the delivery person has succeeded.

In order to achieve the above object, a package reception method according to an eighth aspect of the present invention includes,
by a computer:
generating biometric information of an addressee upon acquiring trigger information for starting biometric authentication of the addressee when the addressee receives a package; and
executing biometric authentication of the addressee, based on the biometric information, or transmitting the biometric information to a delivery control apparatus for controlling delivery of the package.

In order to achieve the above object, a package reception method according to a ninth aspect of the present invention includes,
by a computer:
acquiring, from a delivery person terminal, second identification information for proving that a delivery person is a person in charge of delivery of the package; and
mutually communicating with a delivery control apparatus for controlling delivery of the package, wherein
in the communicating, the second identification information is transmitted to the delivery control apparatus when the second identification information is acquired.

In order to achieve the above object, a program according to a tenth aspect of the present invention is
a program for causing a computer to execute any one method of a delivery control method, a responsibility determination method, a package reception method, and a package control method.

### Advantageous Effects of Invention

According to the present invention, it becomes possible to improve convenience relating to reception of a package. According to the present invention, it becomes possible to make an improvement in reliability of delivery.

### BRIEF DESCRIPTION OF THE DRAWINGS

FIG. 1 is a diagram for describing an outline of a configuration of a delivery control system according to a first example embodiment of the present invention.

FIG. 2 is a diagram illustrating a functional configuration of a delivery control apparatus according to the first example embodiment of the present invention.

FIG. 3 is a diagram illustrating one example of a configuration of delivery person data according to the first example embodiment.

FIG. 4 is a diagram illustrating one example of a configuration of addressee data according to the first example embodiment.

FIG. 5 is a diagram illustrating one example of a configuration of delivery data according to the first example embodiment.

FIG. 6 is a diagram illustrating a functional configuration of a responsibility request unit according to the first example embodiment.

FIG. 7 is a diagram illustrating a functional configuration of a first authentication unit according to the first example embodiment.

FIG. 8 is a diagram illustrating a functional configuration of a second authentication unit according to the first example embodiment.

FIG. 9 is a diagram illustrating a functional configuration of a delivery person terminal according to the first example embodiment of the present invention.

FIG. 10 is a diagram illustrating a functional configuration of an addressee terminal according to the first example embodiment of the present invention.

FIG. 11 is a diagram illustrating a configuration of a package control system according to the first example embodiment of the present invention.

FIG. 12 is a diagram illustrating one example of a configuration of package control data according to the first example embodiment.

FIG. 13 is a diagram illustrating a physical configuration of a delivery control apparatus according to the first example embodiment of the present invention.

FIG. 14 is a diagram illustrating a physical configuration of the delivery person terminal according to the first example embodiment of the present invention.

FIG. 15 is a diagram illustrating a physical configuration of a package control terminal according to the first example embodiment of the present invention.

FIG. 16 is a diagram illustrating one example of a flow of delivery request processing according to the first example embodiment of the present invention.

FIG. 17 is a diagram illustrating one example of a flow of responsibility determination processing according to the first example embodiment of the present invention.

FIG. 18 is a diagram illustrating one example of a flow of the responsibility determination processing according to the first example embodiment of the present invention.

FIG. 19 is a diagram illustrating one example of a flow of package acceptance processing according to the first example embodiment of the present invention.

FIG. 20 is a diagram illustrating one example of a flow of package reception processing according to the first example embodiment of the present invention.

FIG. 21 is a diagram illustrating one example of a flow of the package reception processing according to the first example embodiment of the present invention.

FIG. 22 is a diagram illustrating one example of a configuration of addressee data according to a second modified example.

FIG. 23 is a diagram illustrating a functional configuration of an addressee terminal according to a third modified example.

FIG. 24 is a diagram illustrating one example of a flow of package acceptance processing according to the third modified example.

FIG. 25 is a diagram illustrating one example of a flow of the package acceptance processing according to the third modified example.

FIG. 26 is a diagram illustrating a functional configuration of a delivery person terminal according to a fourth modified example.

FIG. 27 is a diagram illustrating a functional configuration of an addressee terminal according to the fourth modified example.

FIG. 28 is a diagram illustrating one example of a flow of package reception processing according to the fourth modified example.

FIG. 29 is a diagram for describing an outline of a configuration of a delivery control system according to a second example embodiment of the present invention.

FIG. 30 is a diagram illustrating a functional configuration of a package control server according to the second example embodiment of the present invention.

FIG. 31 is a diagram illustrating a functional configuration of a home delivery company server according to the second example embodiment of the present invention.

FIG. 32 is a diagram illustrating one example of a configuration of home delivery company data according to the second example embodiment.

FIG. 33 is a diagram illustrating one example of a flow of package acceptance processing according to the second example embodiment of the present invention.

### DESCRIPTION OF EMBODIMENTS

Hereinafter, example embodiments according to the present invention are described by use of the drawings. Note that, in all of the drawings, a similar component is assigned with a similar reference sign, and description thereof is omitted as appropriate.

### First Example Embodiment

As illustrated in 1 according to a first example embodiment of the present invention, it is a system for controlling delivery of a package P in response to a delivery request from an addressee R of the package P.

The package P is an item delivered by a home delivery company from a sender. The package P is delivered by a home delivery company to a reception place Q specified by the addressee R, and is kept at the reception place Q. The pick-up place Q is, for example, a convenience store, a delivery center, or the like.

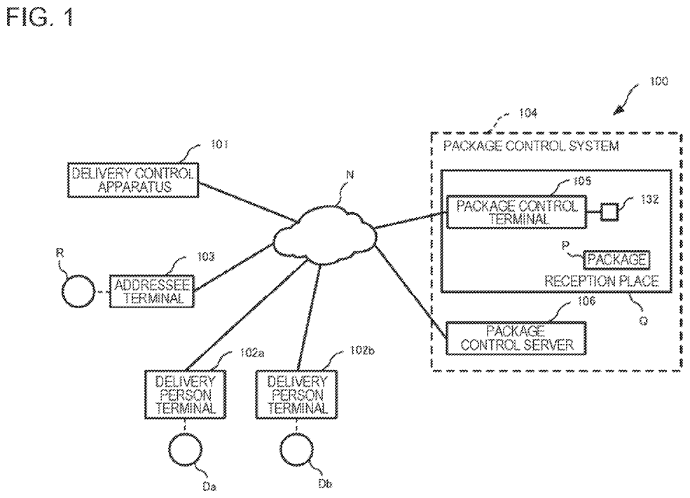

As illustrated in FIG. 1, the delivery control system 100 includes a delivery control apparatus 101 for controlling delivery of the package P, delivery person terminals 102a and 102b each owned by each of delivery persons Da and Db, and an addressee terminal 103 owned by the addressee R. Further, the delivery control system 100 includes a package control system 104 including a package control terminal 105 installed at the reception place Q of the package P, and a package control server 106 that controls the package control terminal 105.

The delivery control apparatus 101, the delivery person terminals 102a and 102b, the addressee terminal 103, the package control terminal 105, and the package control server 106 are connected in such a way as to be capable of transmitting and receiving information to and from each other via a network N. The network N may be composed of a wired line, a wireless line, or a combination thereof.

For example, a point of sales (POS) system is suitable as the package control system 104 when the reception place Q is a convenience store. In this case, package control terminal 105 is a POS terminal. A POS terminal is an apparatus generally utilized for settlement of a product purchased by a customer, and is also utilized for inputting and outputting or the like of information relating to various services provided at a convenience store, such as keeping of the package P. The package control server 106 is a server that controls a POS terminal.

The package control system 104 when the reception place Q is a delivery center is preferably a system for controlling delivery of the package P by a home delivery company. In this case, the package control terminal 105 is an apparatus generally utilized for acceptance of shipment of a package at a delivery center, and is also utilized for inputting and outputting or the like of information relating to handover of the package P kept at the delivery center. The package control server 106 is a server that controls the package control terminal 105, and is equivalent to a home delivery company server.

In the following, when the delivery persons Da and Db are not particularly distinguished, an expression “delivery person D” is also used as a generic name thereof. Moreover, when the delivery person terminals 102a and 102b are not particularly distinguished, an expression “delivery person terminal 102” is also used as a generic name thereof.

### <Functional Configuration of Delivery Control Apparatus 101>

When receiving a delivery request for the package P from the addressee R, the delivery control apparatus 101 controls the delivery of the package P by the delivery person D from the reception place Q to the delivery location specified by the addressee R.

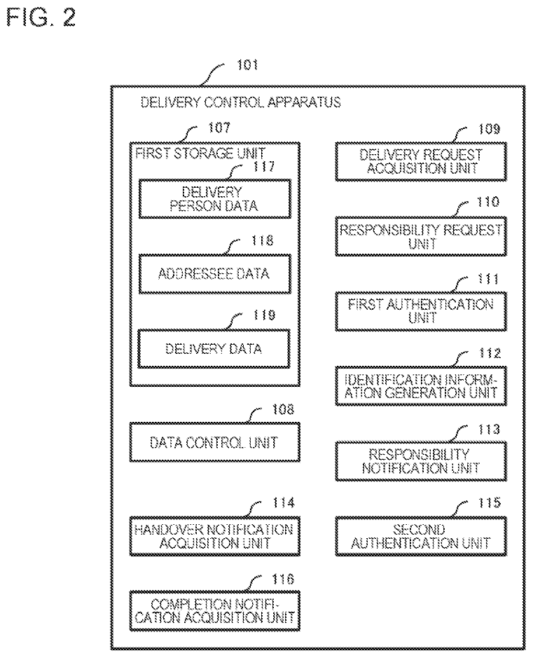

As illustrated in FIG. 2, the delivery control apparatus 101 functionally includes a first storage unit 107, a data control unit 108, a delivery request acquisition unit 109, a responsibility request unit 110, a first authentication unit 111, an identification information generation unit 112, a responsibility notification unit 113, a handover notification acquisition unit 114, a second authentication unit 115, and a completion notification acquisition unit 116.

The first storage unit 107 is a storage unit that stores various pieces of data such as delivery person data 117, addressee data 118, and delivery data 119.

### (Configuration of Delivery Person Data 117)

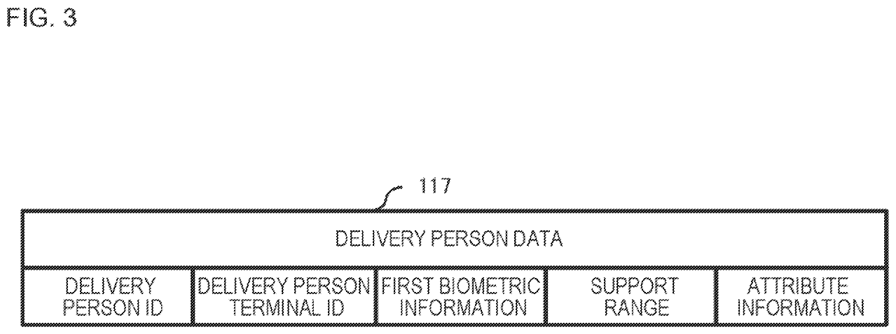

The delivery person data 117 are data relating to the delivery person D. As illustrated in FIG. 3, the delivery person data 117 according to the present example embodiment are data associating, for each of the delivery persons Da and Db, a delivery person identification (ID), a delivery person terminal ID, first biometric information, a support range, and attribute information. Each piece of information constituting the delivery person data 117 is previously registered.

The delivery person ID is information for identifying the delivery person D. The delivery person ID is typically determined when the delivery person D is registered in the delivery person data 117.

The delivery person terminal ID is information for identifying the delivery person terminal 102 owned by the delivery person D. In the present example embodiment, it is assumed that the delivery person terminal ID is able to be utilized as a contact point for the delivery control apparatus 101 to transmit various pieces of information such as a request and a notification to the delivery person terminal 102.

Note that, the delivery person terminal ID may not be a contact point of the delivery person terminal 102, and, in this case, the delivery person data 117 may include a contact point for the delivery control apparatus 101 to transmit information to the delivery person terminal 102.

The first biometric information is the biometric information of the delivery person D. In the present example embodiment, a case where the first biometric information is face information of the delivery person D is described as an example. Face information of the delivery person D being the first biometric information according to the present example embodiment may be a face image of the delivery person D, and may be a feature value acquired by processing the face image of the delivery person D, or another piece of information. Moreover, face information of the delivery person D may be information acquired by any combination of a face image of the delivery person D, a feature value acquired by processing the face image, and another piece of information. Herein, a face image is an image including a face.

Note that, the first biometric information is not limited to face information of the delivery person D, and may be, for example, fingerprint information, vein information, voice information, or the like of the delivery person D.

The support range is information indicating a range in which the delivery person D is capable of delivering the package P. The support range may be set based on specification of the delivery person D.

Attribute information is information indicating an attribute of the delivery person D, such as a gender and an age group of the delivery person D.

### (Configuration of Addressee Data 118)

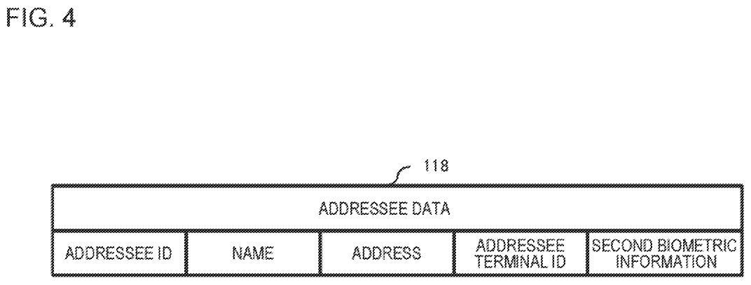

The addressee data 118 are data relating to the addressee R. The addressee data 118 according to the present example embodiment are, as one example of a configuration thereof is illustrated in FIG. 4, data associating an addressee ID, a name, an address, an addressee terminal ID, and second biometric information. Each piece of information constituting the addressee data 118 is previously registered.

The addressee ID is information for identifying the addressee R. The addressee ID is typically determined when the addressee R is registered in the addressee data 118.

The name is information indicating a name of the addressee R. The address is information indicating an address of the addressee R.

The addressee terminal ID is information for identifying the addressee terminal 103 owned by the addressee R. In the present example embodiment, it is assumed that the addressee terminal ID is able to be utilized as a contact point for the delivery control apparatus 101 to transmit various pieces of information such as a request and a notification to the addressee terminal 103.

Note that, the addressee terminal ID may not be a contact point of the addressee terminal 103, and, in this case, the addressee data 118 may include a contact point for the delivery control apparatus 101 to transmit information to the addressee terminal 103.

The second biometric information is biometric information of the addressee R. In the present example embodiment, a case where the second biometric information is face information of the addressee R is described as an example. The face information of the addressee R being the second biometric information according to the present example embodiment may be a face image of the addressee R, or may be a feature value acquired by processing a face image of the addressee R or another piece of information. Moreover, the face information of the addressee R may be information acquired by any combination of a face image of the addressee R, a feature value acquired by processing the face image, and another piece of information.

Note that, the second biometric information may be an image capturing a face of the addressee R. Moreover, the second biometric information is not limited to face information of addressee R, and may be, for example, fingerprint information, vein information, voice information, and the like of the addressee R.

### (Configuration of Delivery Data 119)

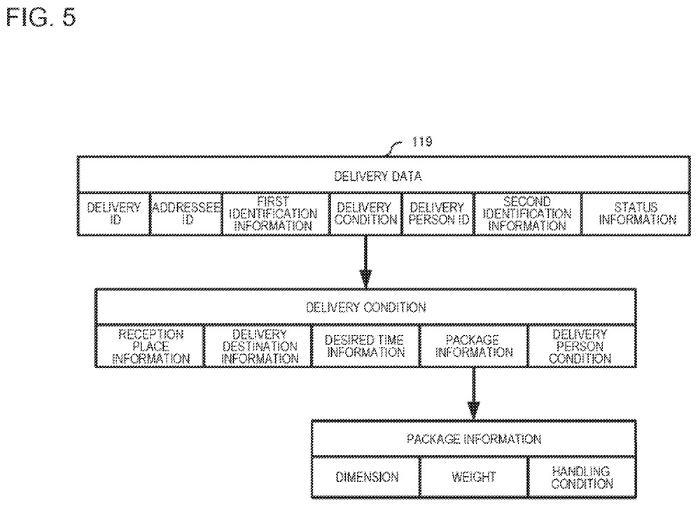

The delivery data 119 are data relating to delivery of the package P from the reception place Q to a delivery destination specified by the addressee R. The delivery data 119 according to the present example embodiment are, as one example of a configuration thereof is illustrated in FIG. 5, data associating a delivery ID, an addressee ID, first identification information, a delivery condition, a delivery person ID, second identification information, and status information.

The delivery ID is information for identifying delivery of the package P from the reception place Q to a delivery destination.

The addressee ID is information for identifying the addressee P of the package P. The addressee ID of the delivery data 119 and the addressee ID of the addressee data 118 are pieces of information common to the same addressee P.

The first identification information is information for identifying the package P. The first identification information is information attached to the package P at a time point when the package P is delivered to the reception place Q, and is, for example, information attached to the package P by the home delivery company delivering the package P to the reception place Q.

The delivery condition is information indicating a condition relating to delivery of the package P. The delivery condition includes, as illustrated in FIG. 5, reception place information, delivery destination information, desired time information, package information, and a delivery person condition.

The reception place information is information indicating the reception place Q where the package P is kept. For the reception place, for example, an address of the reception place Q, a name of a business operator of a convenience store or a collection delivery center being the reception place Q, and a branch name thereof, and the like are set.

The delivery destination information is information indicating a delivery destination of the package P. The delivery destination information includes, for example, an address of a delivery destination specified by the addressee R.

The desired time information is information indicating a desired time of the addressee R relating to reception of the package P. The desired time may be specified by a date and a time, or may be specified by a date and a time period. Moreover, when the addressee R wishes to receive the package P as soon as possible, the desired time may not be specified, and the desired time information may not be set in the delivery data 119.

The package information is information relating to the package P. The package information includes a dimension, weight, and a handling condition, as illustrated in FIG. 5. The package information is preferably set to an extent that the addressee R is able to be found out when a delivery request is made, but may not be set in the delivery data 119.

The dimension is information indicating a dimension of the package P, and includes, for example, an approximate length of the package P in each of longitudinal, lateral, and height directions. The weight is information indicating weight of the package P, and includes, for example, approximate weight of the package P. The handling condition is information indicating a matter to be noted in relation to handling of the package P, such as a fragile item, precision machinery, and do-not-turn-over (prohibition of delivery in an upside-down state or a tilted state).

The delivery person condition is information indicating a condition specified by the addressee R regarding the delivery person D, and includes, for example, an attribute of the delivery person D, such as a gender and an age group of the delivery person D. The delivery person condition may not be set in the delivery data 119 when not specified by the addressee R.

The delivery person ID is information for identifying the delivery person D who is in charge of delivering the package P. The delivery person ID of the delivery data 119 and the delivery person ID of the delivery person data 117 are information common to the same delivery person D.

The second identification information is information for proving that the delivery person D is a person in charge of delivering the package P, and is, for example, a code combining signs such as a letter, a symbol, and a number.

The status information is information indicating status of delivery of the package P. For example, “responsibility undetermined”, “package being received”, “delivery in progress”, “delivery complete”, and the like are set for the status information.

The “responsibility undetermined” is one example of information indicating that the delivery person D in charge of delivery of the package P has not yet been determined.

The “package being received” is one example of information indicating that the delivery person D is on his/her way to pick up the package P at the reception place Q (i.e., the delivery person D in charge of delivery of the package P is in a state of having not accepted the package P yet).

The “delivery in progress” is one example of delivery-in-progress information indicating that the delivery person D is delivering the package P (i.e., the delivery person D in charge of delivery of the package P receives the package P at the reception place Q and is in a state of being on his/her way to a delivery destination).

The “delivery complete” is one example of information indicating that delivery of the package P has been completed.

Again, FIG. 2 is referred to.

The data control unit 108 controls the first storage unit 107. Specifically, the data control unit 108 registers new data in the first storage unit 107. Moreover, the data control unit 108 also modifies or deletes existing data stored in the first storage unit 107.

The delivery request acquisition unit 109 acquires a delivery request from the addressee terminal 103.

The delivery request is information for the addressee R to request delivery of the package P, and includes first identification information for identifying the package P. Moreover, the delivery request includes at least one of an addressee ID of the addressee R and an addressee terminal ID of the addressee terminal 103, reception place information indicating the reception place Q, and delivery destination information. Further, the delivery request includes desired time information, package information, and a delivery person condition when specified or input by the addressee R.

The responsibility request unit 110 transmits a responsibility request for delivery of the package P to each of the delivery person terminals 102. The responsibility request is information for requesting the delivery person D to be in charge of delivery of the package P for which a delivery request has been received.

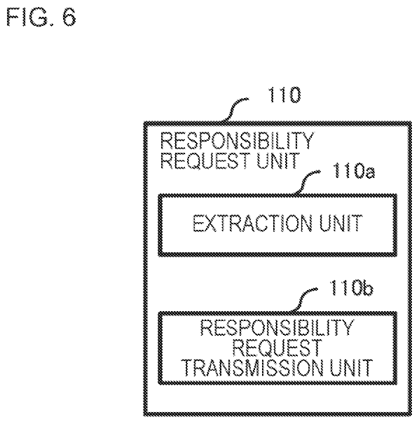

Specifically, the responsibility request unit 110 transmits a responsibility request to the delivery person terminal 102 of the delivery person D of whom delivery destination is included in the support range. Further, when the delivery request includes a delivery person condition, the responsibility request unit 110 transmits a responsibility request to the delivery person D who meets a conditions included in the delivery person condition. As illustrated in FIG. 6, the responsibility request unit 110 includes an extraction unit 110a and a responsibility request transmission unit 110b.

When a delivery request is acquired, the extraction unit 110a extracts a delivery person ID being associated with the support range of the delivery person data 117 including a delivery destination included in the delivery request. Further, when a delivery request includes a delivery person condition, the extraction unit 110a extracts a delivery person ID being associated with an attribute of the delivery person data 117 that meet an attribute included in the delivery person condition.

Thereby, the extraction unit 110a is able to extract the delivery person ID of the delivery person D that includes the delivery destination in a support range and that meets a delivery person condition when the delivery person condition specified.

The responsibility request transmission unit 110b transmits a responsibility request to the delivery person terminal 102 of a delivery person terminal ID being associated in the delivery person data 117 with a delivery person ID extracted by the extraction unit 110a.

Again, FIG. 2 is referred to.

The first authentication unit 111 performs first authentication, based on first biometric information acquired from the delivery person terminal 102 of the delivery person D responding to a responsibility request. The first authentication is processing for biometric authentication of the delivery person D. The first authentication unit 111 is equivalent to a delivery person authentication unit.

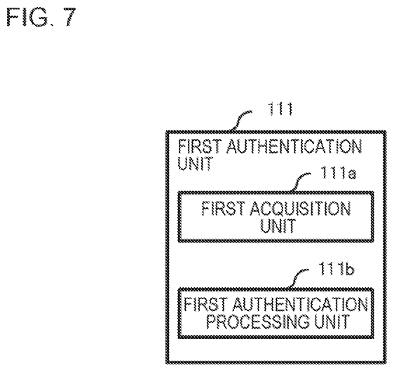

Specifically, the first authentication unit 111 performs the first authentication, based on whether first biometric information being relevant to the first biometric information acquired from the delivery person terminal 102 is registered in the delivery person data 117. The first authentication unit 111 includes, as illustrated in FIG. 7, a first acquisition unit 111a and a first authentication processing unit 111b.

The first acquisition unit 111a acquires a delivery person ID of the delivery person D or a delivery person terminal ID of the delivery person terminal 102, and first biometric information, from the delivery person terminal 102 of the delivery person D responding to a responsibility request.

The first authentication processing unit 111b refers to the first storage unit 107, and acquires the delivery person data 117 being relevant to the delivery person ID or the delivery person terminal ID acquired by the first acquisition unit 111a. The first authentication processing unit 111b compares the first biometric information acquired by the first acquisition unit 111a with the first biometric information included in the delivery person data 117, and thereby performs authentication (first authentication) of the delivery person D.

For example, when the first biometric information acquired by the first acquisition unit 111a is a face image of the delivery person D, and the first biometric information included in the delivery person data 1117 is a feature value, the first authentication processing unit 111b first extracts the feature value by processing the face image being the first biometric information acquired by the first acquisition unit 111. Next, the first authentication processing unit 111b compares the extracted feature value with the feature value being the first biometric information included in the delivery person data 117.

As a result of the comparison, when the difference between the feature values is within a previously determined allowable range, the first authentication processing unit 111b determines that the first authentication has succeeded. The first authentication processing unit 111b determines that the first authentication has failed when the difference between the feature values exceeds the previously determined allowable range.

Note that, the first authentication by the first authentication processing unit 111b is not limited to the example described above, and various methods may be adopted. The first authentication may be performed, based on, for example, a comparison between images, a comparison between feature values, or a comparison between other pieces of information, or may be performed by comparing pieces of information acquired by any combination of the former pieces of information.

Again, FIG. 2 is referred to.

The identification information generation unit 112 generates second identification information for proving that the delivery person D is the person in charge of delivering the package P when the first authentication has succeeded.

Moreover, the identification information generation unit 112 sets the generated second identification information in the delivery data 119 via the data control unit 108. In this instance, the data control unit 108 sets the second identification information in association with the delivery person ID of the delivery person D who has succeeded in the first authentication.

The responsibility notification unit 113 transmits the second identification information generated by the identification information generation unit 112 to the delivery person terminal 102 of the delivery person D being a person in charge of delivery of the package P. Moreover, the responsibility notification unit 113 transmits the second identification information generated by the identification information generation unit 112 to the package control server 106 together with the first identification information included in the delivery request.

When the package P is handed over to the delivery person D at the reception place Q, the handover notification acquisition unit 114 acquires, from the package control terminal 105, a notification of package handover indicating the fact.

The second authentication unit 115 performs second authentication, based on the second biometric information acquired from the addressee terminal 103 of the addressee R. The second authentication is processing for biometric authentication of the addressee R. The second authentication is performed by the delivery person D for the addressee R to confirm that the addressee R is a correct addressee of the package P, when the package P is passed over to the addressee R. The second authentication unit 115 is equivalent to an addressee authentication unit.

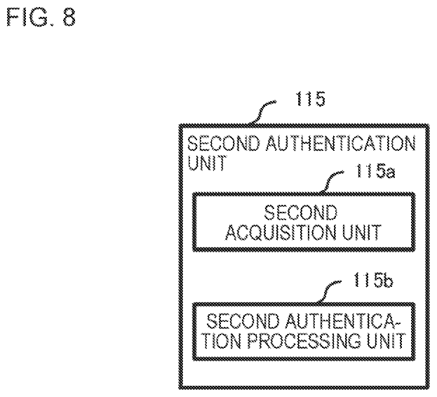

Specifically, the second authentication unit 115 performs the second authentication, based on whether the second biometric information being relevant to the second biometric information acquired from the addressee terminal 103 is registered in the addressee data 118. The second authentication unit 115 includes, as illustrated in FIG. 8, a second acquisition unit 115a and a second authentication processing unit 115b.

Upon acquiring a reception request for the package P from the delivery person terminal 102 of the delivery person D, the second acquisition unit 115a transmits the reception request to the delivery person terminal 102. This causes the addressee terminal 103 of the addressee R to execute processing for generating second biometric information being biometric information of the addressee R.

The reception request is information for the delivery person D to request the addressee R for execution of the second authentication, and is one example of trigger information serving as a trigger for starting the second authentication when delivering the package P to the addressee R.

Then, the second acquisition unit 115a acquires second biometric information generated by the addressee terminal 103 of the addressee R, from the addressee terminal 103 in response to the reception request together with an addressee ID of the addressee R or an addressee terminal ID of the addressee terminal 103.

Note that, the delivery person terminal 102 and the addressee terminal 103 may be configured in such a way as to be able to directly transmit and receive trigger information, and, in this case, the second acquisition unit 115a may not transfer, to the addressee terminal 103, a reception request from the delivery person terminal 102.

The second authentication processing unit 115b refers to the first storage unit 107, and acquires the addressee data 118 being relevant to an addressee ID or an addressee terminal ID acquired by the second acquisition unit 115a. The second authentication processing unit 115b compares the second biometric information acquired by the second acquisition unit 115a with the second biometric information included in the addressee data 118, and thereby performs authentication (second authentication) of the addressee R.

For example, when second biometric information acquired by the second acquisition unit 115a is a face image of the addressee R, and second biometric information included in the addressee data 118 is a feature value, the second authentication processing unit 115b first extracts the feature value by processing the face image being the second biometric information acquired by the second acquisition unit 115a. Next, the second authentication processing unit 115b compares the extracted feature value with the feature value being the second biometric information included in the addressee data 118.

As a result of the comparison, when a difference between the feature values is within a previously determined allowable range, the second authentication processing unit 115b determines that the second authentication has succeeded. The second authentication processing unit 115b determines that the second authentication has failed when the difference between the feature values exceeds the previously determined allowable range.

Note that, the second authentication by the second authentication processing unit 115b is not limited to the example described above, and various methods may be adopted. The second authentication may be performed, based on, for example, a comparison between images, a comparison between feature values, a comparison between other pieces of information, or may be performed by comparing pieces of information acquired by any combination of the former pieces of information.

Again, FIG. 2 is referred to.

When the package P is handed over to the addressee R and the delivery of the package P is completed, the completion notification acquisition unit 116 acquires, from the delivery person terminal 102, a notification of delivery completion indicating the fact.

### <Functional Configuration of Delivery Person Terminal 102>

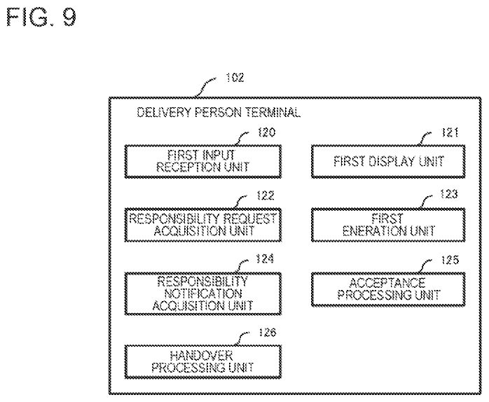

As illustrated in FIG. 9, the delivery person terminal 102 functionally includes a first input reception unit 120, a first display unit 121, a responsibility request acquisition unit 122, a first generation unit 123, a responsibility notification acquisition unit 124, an acceptance processing unit 125, and a handover processing unit 126.

The first input reception unit 120 receives input from the delivery person D. The first display unit 121 displays various pieces of information.

The responsibility request acquisition unit 122 acquires, from the delivery control apparatus 101, a responsibility request for delivery of the package P.

The first generation unit 123 generates first biometric information of the delivery person D in response to the input of the delivery person D who responds to a responsibility request, that is to say, the delivery person D who desires to be in charge of delivery of the package P. Specifically, the first generation unit 123 captures a face image of the delivery person D in response to input of the delivery person D, and generates face information as first biometric information, based on the face image.

The responsibility notification acquisition unit 124 acquires second identification information from the delivery control apparatus 101. As described above, the second identification information is transmitted from the delivery control apparatus 101 when the first authentication based on the first biometric information has succeeded.

The acceptance processing unit 125 performs processing for the delivery person D to accept the package P at the reception place Q. Specifically, for example, the acceptance processing unit 125 causes the first display unit 121 to display the second identification information acquired by the responsibility notification acquisition unit 124, in response to input of a delivery person D at the reception place Q of the package P.

Thereby, the first display unit 121 displays the second identification information at the reception place Q of the package P. In this instance, the second identification information may be displayed as a combination of codes such as a letter, a symbol, and a number, or may be displayed as an image of a one-dimensional code, a two-dimensional code, or the like including a combination of codes.

The handover processing unit 126 performs processing for the delivery person D to hand over the package P to the addressee R. Specifically, for example, the handover processing unit 126 transmits a reception request to the delivery control apparatus 101 in response to input from the delivery person D when the delivery person D hands over the package P to the addressee R. Then, the handover processing unit 126 acquires a result of the second authentication performed in response to the reception request.

### <Functional Configuration of Addressee Terminal 103>

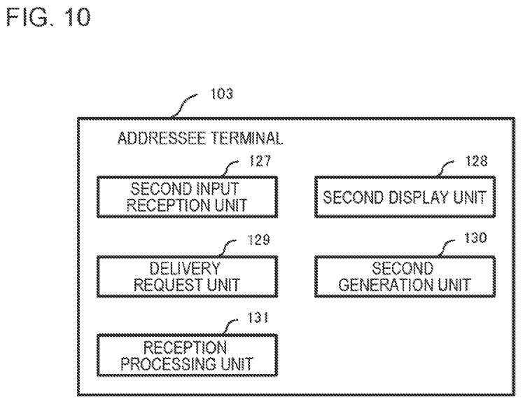

As illustrated in FIG. 10, the addressee terminal 103 functionally includes a second input reception unit 127, a second display unit 128, a delivery request unit 129, a second generation unit 130, and a reception processing unit 131.

The second input reception unit 127 receives input from the addressee R. The second display unit 128 displays various pieces of information.

In response to the input of the addressee R, the delivery request unit 129 generates a delivery request for the package P, and transmits the generated delivery request to the delivery control apparatus 101.

Upon acquiring a reception request for the package P from the delivery control apparatus 101, the second generation unit 130 generates second biometric information of the addressee R. Specifically, the second generation unit 130 captures a face image of the addressee R in response to input of the addressee R after the reception request is acquired, and generates face information as the second biometric information, based on the face image. Note that, the reception request may be acquired from the delivery person terminal 102.

The reception processing unit 131 performs processing for the addressee R to receive the package P from the delivery person D. Specifically, for example, the reception processing unit 131 transmits biometric information generated by the second generation unit 130 to the delivery control apparatus 101.

### <Functional Configuration of Package Control System 104>

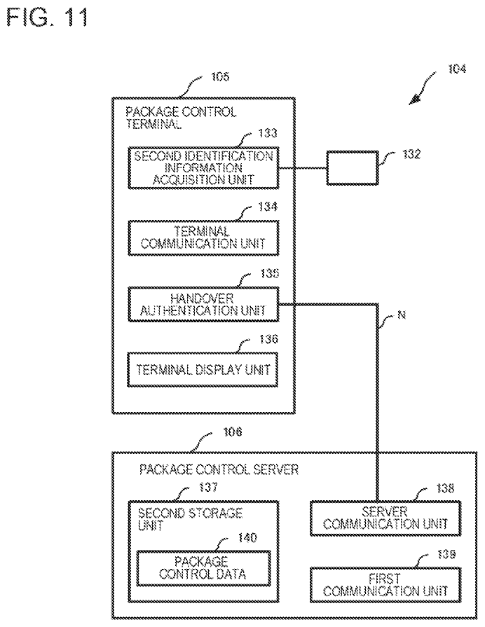

As illustrated in FIG. 11, the delivery control system 100 includes the package control terminal 105 to which a hand scanner 132 is connected, and the package control server 106 that controls the package control terminal 105. The hand scanner 132 is an apparatus that reads a code represented by an image, a character, and the like, and is one example of a scanner.

Note that, the scanner is not limited to the hand scanner 132, and may be various scanners. Moreover, the scanner may be provided integrally with the package control terminal 105.

### (Functional Configuration of Package Control Terminal 105)

As illustrated in FIG. 11, the package control terminal 105 functionally includes a second identification information acquisition unit 133, a terminal communication unit 134, a handover authentication unit 135, and a terminal display unit 136.

The second identification information acquisition unit 133 acquires the second identification information from the delivery person terminal 102. In the present example embodiment, when the second identification information displayed on the first display unit 121 is read by the hand scanner 132, the second identification information acquisition unit 133 acquires, from the hand scanner 132, the second identification information read by the hand scanner 132.

The terminal communication unit 134 transmits and receives various pieces of information to and from the package control server 106 by mutually communicating with the package control server 106.

The handover authentication unit 135 performs processing for handing over the package P to the delivery person D at the reception place Q.

Specifically, for example, the handover authentication unit 135 performs handover authentication being processing for confirming that the delivery person D who has come to receive the package P is a person in charge of the package P. Thus, when second identification information is acquired by the second identification information acquisition unit 133, the second identification information is transmitted to the package control server 106 via the terminal communication unit 134, and an inquiry is made as to whether the second identification information is registered in package control data 140 (details are described later).

Note that, the package control data 140 may be previously transmitted from the package control server 106 to the package control terminal 105, and held in the package control terminal 105, for example, the handover authentication unit 135 or the like. In this case, when second identification information is acquired by the second identification information acquisition unit 133, the handover authentication unit 135 may perform handover authentication, based on whether the second identification information is registered in the package control data 140 previously held by the handover authentication unit 135.

Upon acquiring a response indicating that the second identification information is registered in the package control data 140, the handover authentication unit 135 determines that the handover authentication has succeeded. When a response indicating that the second identification information is not registered in the package control data 140 is acquired, it is determined that the handover authentication has failed. When the handover authentication succeeds, the package P is handed over to the delivery person D at the reception place R.

The terminal display unit 136 displays various pieces of information.

### (Functional Configuration of Package Control Server 106)

As illustrated in FIG. 11, the package control server 106 functionally includes a second storage unit 137, a server communication unit 138, and a first communication unit 139.

The second storage unit 137 is a storage unit that stores various pieces of data such as package control data 140.

### (Configuration of Package Control Data 140)

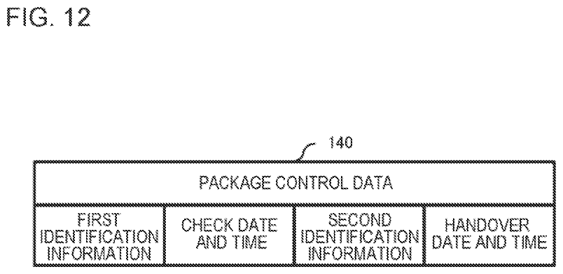

The package control data 140 are data for controlling the package P in the package control system 104. The package control data 140 according to the present example embodiment are, as one example of a configuration thereof is illustrated in FIG. 12, data associating first identification information, a check date and time, second identification information, and a handover date and time.

The first identification information and the check date and time are pieces of information set when the package P is delivered to the reception place Q by a home delivery company. The first identification information of the package control data 140 and the first identification information of the delivery data 119 are pieces of information common to the same package P. The check date and time is information indicating a date and time when the package P is delivered to the reception place Q.

The second identification information is set when generated in relation to delivery of the package P identified by the first identification information associated with the second identification information. The second identification information of the package control data 140 and the second identification information of the delivery data 119 are common information generated in relation to delivery of the package P.

The handover date and time is information indicating a date and time when the package P identified by the first identification information associated with the handover date and time is handed over to the delivery person D.

Again, FIG. 11 is referred to.

The server communication unit 138 transmits and receives various pieces of information to and from the package control terminal 105 by mutually communicating with the package control terminal 105.

Specifically, for example, the server communication unit 138 receives, from the package control terminal 105, an inquiry as to whether second identification information is registered in the package control data 140.

In response to the inquiry, the server communication unit 138 refers to the package control data 140, and thereby transmits, to the package control terminal 105, a response including whether second identification information is registered in the package control data 140. Moreover, when the package P is handed over to the delivery person D, the server communication unit 138 sets the date and time at that time as a handover date and time of the package control data 140.

Note that, the inquiry from the package control terminal 105 may be an inquiry as to whether the first identification information and the second identification information are registered in the package control data 140 in association with each other. In this case, the server communication unit 138 may transmit, to the package control terminal 105, a response including whether the first identification information and the second identification information are registered in the package control data 140 in association with each other.

The first communication unit 139 transmits and receives information to and from the delivery control apparatus 101 by mutually communicating with the delivery control apparatus 101.

Specifically, for example, the first communication unit 139 acquires the second identification information generated in relation to delivery of the package P from the delivery control apparatus 101 together with the first identification information for identifying the package P. Thereby, the first communication unit 139 sets the second identification information in the package control data 140 in association with the first identification information of the package control data 140 being relevant to the acquired first identification information.

Moreover, for example, when a notification of package handover indicating that the package P has been handed over to the delivery person Da is acquired by the terminal communication unit 134, the first communication unit 139 transmits a notification of package handover including the second identification information to the delivery control apparatus. That is to say, when the second identification information is acquired by the second identification information acquisition unit 133 and the package P is handed over to a delivery person Da, the first communication unit 139 transmits the second identification information to the delivery control apparatus 101. Thereby, the delivery control apparatus 101 can control a fact that the package P has been handed over to the delivery person D.

Note that, each function of the package control terminal 105 and each function of the package control server 106 described in the present example embodiment may be provided in the package control system 104. That is to say, some or all of the functions of the package control terminal 105 according to the present example embodiment may be provided in the package control server 106, and some or all of the functions of the package control server 106 according to the present example embodiment may be provided in the control terminal 105.

### <Physical Configuration of Delivery Control System 100>

The delivery control system 100 is physically constituted of the delivery control apparatus 101, the delivery person terminal 102, the addressee terminal 103, the package control terminal 105, and the package control server 106 that are connected via the network N.

The delivery control apparatus 101 is physically, for example, a general-purpose computer.

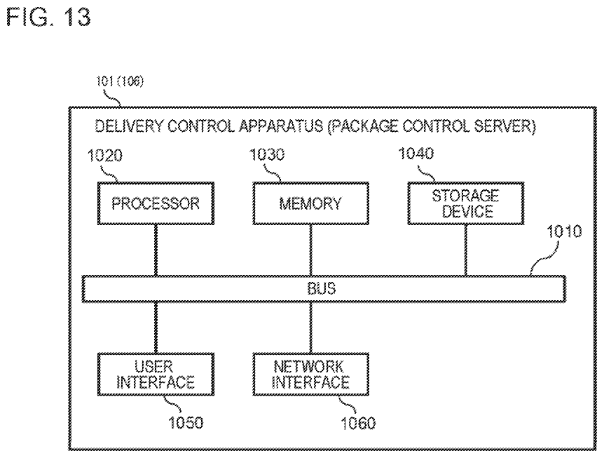

Specifically, for example, the delivery control apparatus 101 physically includes a bus 1010, a processor 1020, a memory 1030, a storage device 1040, a user interface 1050, and a network interface 1060, as illustrated in FIG. 13.

The bus 1010 is a data transmission path through which the processor 1020, the memory 1030, the storage device 1040, the user interface 1050, and the network interface 1060 transmit and receive data to and from each other. However, a method of connecting the processor 1020 and the like to each other is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function of the delivery control apparatus 101. The processor 1020 reads each of the program modules onto the memory 1030, executes the read program module, and thereby achieves each function being relevant to the program module.

The user interface 1050 is a touch panel, a keyboard, a mouse, or the like as an interface for a user to input information, and a liquid crystal panel or the like as an interface for presenting information to a user.

The network interface 1060 is an interface for connecting the delivery control apparatus 101 to the network N.

The package control server 106 may physically include a configuration similar to that of the delivery control apparatus 101.

The delivery person terminal 102 is physically, for example, a tablet personal computer (PC), a smartphone, or the like.

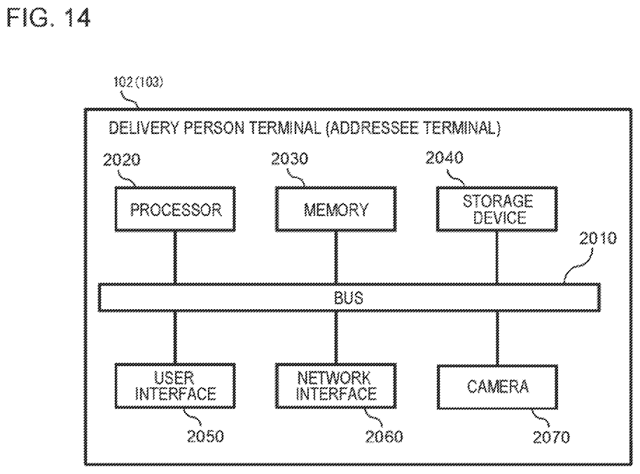

Specifically, for example, the delivery person terminal 102 physically includes a bus 2010, a processor 2020, a memory 2030, a storage device 2040, a user interface 2050, a network interface 2060, and a camera 2070, as illustrated in FIG. 14.

The bus 2010 is a data transmission path through which the processor 2020, the memory 2030, the storage device 2040, the user interface 2050, the network interface 2060, the camera 2070, and a microphone 2080 transmit and receive data to and from each other. However, a method of connecting the processor 1020 and the like to each other is not limited to bus connection.

The processor 2020 is a processor achieved by a central processing unit (CPU), a graphics processing unit (GPU), or the like.

The memory 2030 is a main storage apparatus achieved by a random access memory (RAM) or the like.

The storage device 2040 is an auxiliary storage apparatus achieved by a hard disk drive (HDD), a solid state drive (SSD), a memory card, a read only memory (ROM), or the like. The storage device 2040 stores a program module that achieves each function of the delivery person terminal 102. The processor 2020 reads each of the program modules onto the memory 2030, executes the read program module, and thereby achieves each function being relevant to the program module.

The user interface 2050 is a touch panel, a keyboard, a mouse, or the like as an interface for a user to input information, and a liquid crystal panel or the like as an interface for presenting information to a user.

The network interface 2060 is an interface for connecting the delivery person terminal 102 to the network N.

The camera 2070 captures an image, and generates image information indicating the image.

The addressee terminal 103 may physically include a configuration similar to that of the delivery person terminal 102.

The package control terminal 105 is physically, for example, a POS terminal, a general-purpose computer to which a scanner 3070 is connected, or the like.

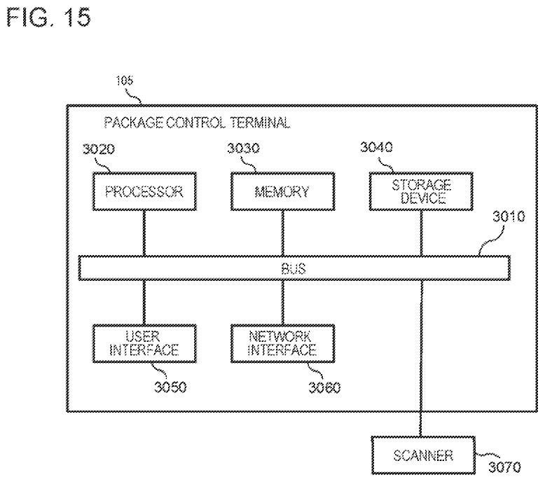

Specifically, for example, the package control terminal 105 physically includes a bus 3010, a processor 3020, a memory 3030, a storage device 3040, a user interface 3050, a network interface 3060, and a scanner 3070, as illustrated in FIG. 15.

The bus 3010 is a data transmission path through which the processor 3020, the memory 3030, the storage device 3040, the user interface 3050, and the network interface 3060 transmit and receive data to and from each other. However, a method of connecting the processor 3020 and the like to each other is not limited to bus connection.

The processor 3020 is a processor achieved by a central processing unit (CPU), a graphics processing unit (GPU), or the like.

The memory 3030 is a main storage apparatus achieved by a random access memory (RAM) or the like.

The storage device 3040 is an auxiliary storage apparatus achieved by a hard disk drive (HDD), a solid state drive (SSD), a memory card, a read only memory (ROM), or the like. The storage device 3040 stores a program module that achieves each function of the package control terminal 105. The processor 3020 reads each of the program modules onto the memory 3030, executes the read program module, and thereby achieves each function being relevant to the program module.

The user interface 3050 is a touch panel, a keyboard, a mouse, or the like as an interface for a user to input information, and a liquid crystal panel or the like as an interface for presenting information to a user.

The network interface 3060 is an interface for connecting the package control terminal 105 to the network N.

The scanner 3070 is an apparatus that reads a character or an image, and outputs read information.

### <<Operation of Delivery Control System 100>>

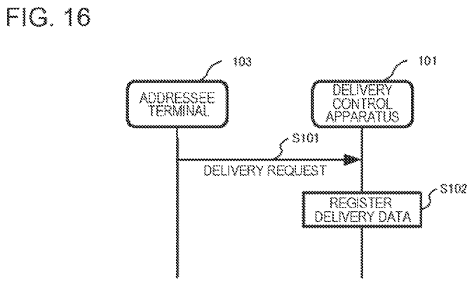

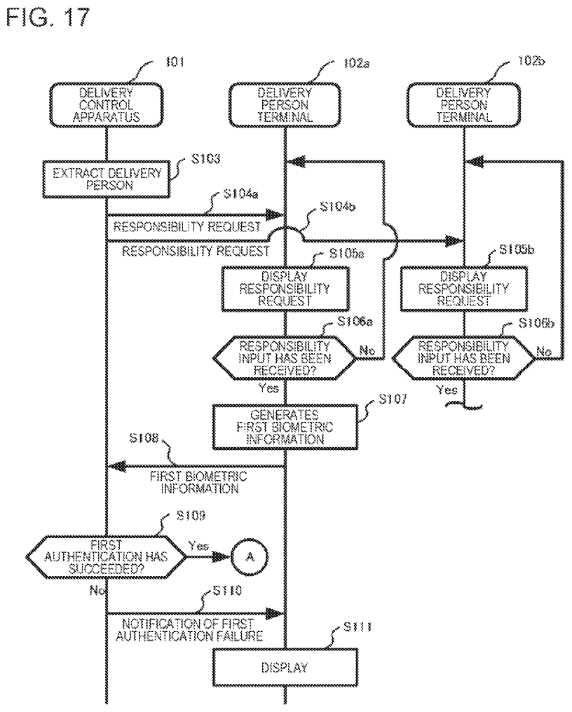

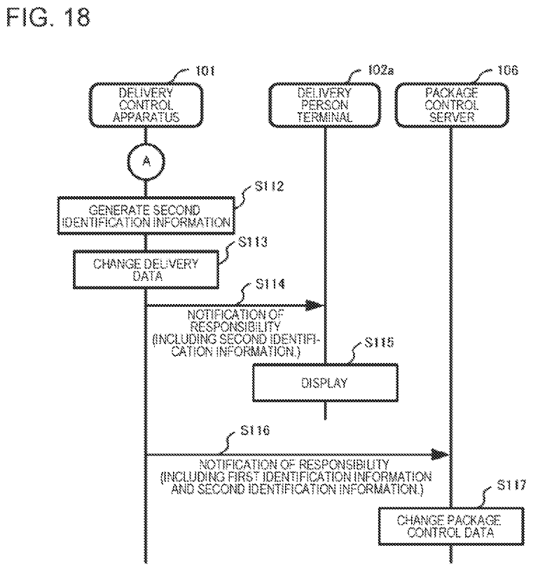

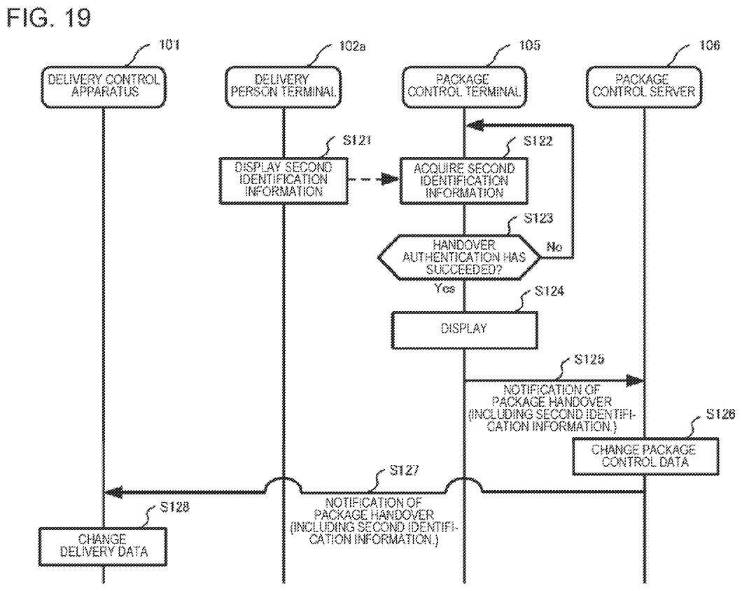

From here, an operation of the delivery control system 100 is described with reference to the drawings. The delivery control system 100 executes delivery control processing for controlling delivery of the package P in response to a delivery request from the addressee R of the package P. The delivery control processing includes delivery request processing illustrated in FIG. 16, responsibility determination processing illustrated in FIGS. 17 and 18, package acceptance processing illustrated in FIG. 19, and package reception processing illustrated in FIG. and 21.

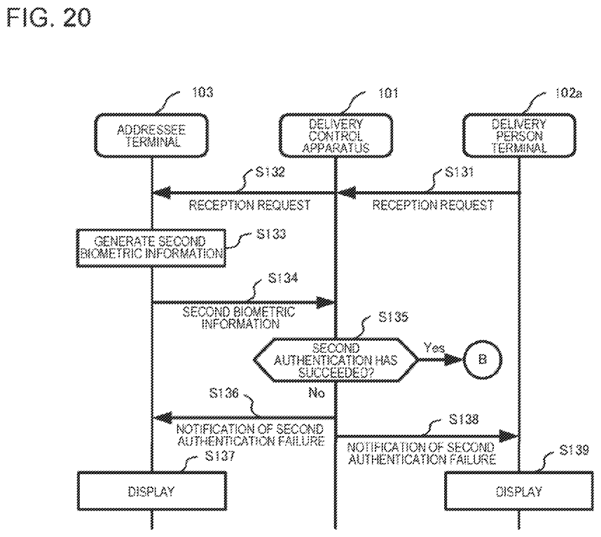

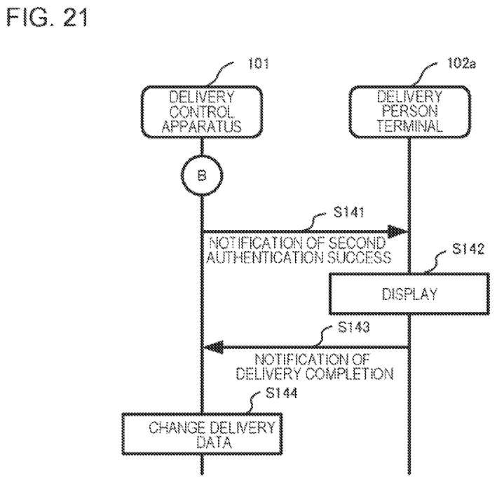

Herein, FIG. 16 is a diagram illustrating one example of a flow of delivery request processing according to the present example embodiment. FIGS. 17 and 18 are diagrams illustrating one example of a flow of responsibility determination processing according to the present example embodiment. FIG. 19 is a diagram illustrating one example of a flow of package acceptance processing according to the present example embodiment. FIGS. 20 and 21 are diagrams illustrating one example of a flow of package reception processing according to the present example embodiment.

The delivery control processing is started by each apparatus (the delivery control apparatus 101, the delivery person terminals 102a and 102b, the addressee terminal 103, the package control terminal 105, and the package control server 106) constituting the delivery control system 100 running a predetermined program installed therein.

It is assumed that the delivery person data 117 and the addressee data 118 are previously set. Moreover, it is assumed that the package P is delivered to and kept at the reception place Q by a home delivery company, and first identification information and a check date and time of the package control data 140 have been set.

### (Delivery Request Processing)

The delivery request processing is processing for the addressee R to request delivery of the package P.

As illustrated in FIG. 16, transmission and reception of a delivery request are performed (step S101).

Specifically, the delivery request unit 129 generates a delivery request for the package P in response to input of the addressee R to the second input reception unit 127, and transmits the delivery request to the delivery control apparatus 101. The delivery request acquisition unit 109 acquires a delivery request from the addressee terminal 103 via the network N. When the delivery request is acquired by the delivery request acquisition unit 109, the data control unit 108 generates the delivery data 119, based on information included in the delivery request, and registers the generated delivery data 119 in the first storage unit 107 (step S102).

In this instance, the delivery ID is generated, for example, in accordance with a previously determined rule, and set in the delivery data 119. An addressee ID, first identification information, a reception place, and a delivery destination are included in the delivery request, and are set in the delivery data 119 according to the delivery request. A desired delivery time, package information, and a delivery person condition are set in the delivery data 119 according to the delivery request, when included in the delivery request.

Moreover, since the delivery person D in charge of deliver of the package P has not yet been determined, a delivery person ID and second identification information are not set (i.e., are, e.g., blank or null values). The status information is set to “responsibility undetermined”.

This completes the delivery request processing.

### (Responsibility Determination Processing)

Subsequently, the responsibility determination processing is executed. The responsibility determination processing is processing for determining the delivery person D in charge of delivery of the package P for which a delivery request has been received. At start of the responsibility determination processing, each of the delivery person terminals 102 is on standby in such a way as to be able to acquire a responsibility request from the delivery control apparatus 101.

As illustrated in FIG. 17, the extraction unit 110a extracts the delivery person D to be a candidate for a person in charge of delivery relating to the delivery request, based on the delivery request acquired in step S101 and the delivery person data 117 (step S103).

Specifically, for example, the extraction unit 110a acquires a delivery destination included in the delivery request acquired in step S101, refers to the delivery person data 117, and extracts the delivery person ID associated with the support range including the delivery destination. Moreover, when the delivery request includes a delivery person condition, the extraction unit 110a extracts the delivery person ID associated with an attribute of the delivery person data 117 that meet an attribute included in the delivery person condition.

Transmission and reception of a responsibility request are performed between the delivery control apparatus 101 and each of the delivery person terminals 102 of the delivery person D extracted by the extraction unit 110a (steps S104a and 104b).

Specifically, for example, the responsibility request transmission unit 110b transmits a responsibility request to the delivery person terminal 102a, and the responsibility request acquisition unit 122 of the delivery person terminal 102a acquires the responsibility request (step S104a). Moreover, the responsibility request transmission unit 110b transmits the responsibility request to the delivery person terminal 102b, and the responsibility request acquisition unit 122 of the delivery person terminal 102b acquires the responsibility request (step S104b).

The responsibility request may include a delivery condition included in the delivery request acquired in step S101, and a delivery ID being relevant to the delivery request.

The first display unit 121 of each of the delivery person terminals 102 displays the delivery request acquired in steps S104a and 104b (steps S105a and 105b).

The first input reception unit 120 of each of the delivery person terminals 102 determines whether responsibility input has been received (steps S106a and 106b). The responsibility input is input for a responsible person D to view a content of a delivery request and respond to the responsibility request.

When responsibility input is not received (step S106a; No, step S106b; No), each of the delivery person terminals 102a and 102b returns to waiting for a responsibility request.

An example in which the delivery person terminal 102a receives responsibility input from the delivery person Da, and the delivery person terminal 102b does not receive responsibility input from the delivery person Db is described below. Thus, in FIG. 17, regarding a case where responsibility input is received at the delivery person terminal 102b (step S106b; Yes), subsequent processing is omitted. When the delivery person terminal 102b receives responsibility input (step S106b; Yes), the delivery person terminal 102b also performs processing similar to processing at the delivery person terminal 102a that is described below.

When responsibility input is received (step S106a; Yes), the first generation unit 123 of the delivery person terminal 102a captures a face image of the delivery person D in response to the input of the delivery person Da, and generates face information as first biometric information, based on the face image (step S107).

Transmission and reception of the first biometric information are performed (step S108).

Specifically, for example, the first generation unit 123 transmits the first biometric information generated in step S107 to the delivery control apparatus 101 together with the delivery ID and the delivery person ID of the delivery person Da included in the delivery request.

The first acquisition unit 111a acquires first biometric information and a delivery ID from the delivery person terminal 102a. Herein, in addition to the delivery person ID of the delivery person Da, or in place of the delivery person ID of the delivery person Da, the delivery person terminal ID of the delivery person terminal 102a may be transmitted and received.

Based on the first biometric information of the delivery person Da acquired in step S108 and the first biometric information of the delivery person Da included in the delivery person data 117, the first authentication processing unit 111b performs first authentication of the delivery person Da (step S109).

When the first authentication has failed, that is to say, when the first authentication has not succeeded (step S109; No), transmission and reception of a notification of first authentication failure indicating that the first authentication of the delivery person Da has failed are performed (step S110).

Specifically, for example, the first authentication processing unit 111b transmits a notification of first authentication failure to the delivery person terminal 102a when the first authentication has failed. The responsibility notification acquisition unit 124 of the delivery person terminal 102a acquires the notification of first authentication failure from the delivery control apparatus 101.

The first display unit 121 of the delivery person terminal 102a displays that the biometric authentication of the delivery person Da has failed (step S111), and ends the responsibility determination processing.

When the first authentication has succeeded (step S109; Yes), the identification information generation unit 112 generates second identification information for proving that the delivery person Da is a person in charge of delivery of the package P, as illustrated in FIG. 18 (step S112).

The data control unit 108 changes the delivery data 119 by the second identification information generated in step S112 (step S113).

Specifically, for example, the data control unit 108 sets the second identification information generated in step S112 in the delivery data 119 in association with the delivery ID related to the second identification information. Moreover, the data control unit 108 changes status information related to the delivery ID to “package being received”.

Transmission and reception of a notification of responsibility including the second identification information generated in step S112 are performed (step S114).

Specifically, the responsibility notification unit 113 transmits, to the delivery person terminal 102a, the notification of responsibility including the second identification information generated in step S112. The responsibility notification acquisition unit 124 of the delivery person terminal 102a acquires the notification of responsibility from the delivery control apparatus 101. Thereby, the delivery person terminal 102a holds information included in a responsibility request for which the responsibility input has been received in step S106a, and the second identification information in association with each other.

The responsibility notification acquisition unit 124 of the delivery person terminal 102a causes the first display unit 121 to display the second identification information acquired in step S114 (step S115). Thereby, the delivery person Da is able to find out that he or she has been determined as a person in charge of delivery of the package P.

Transmission and reception of a notification of responsibility including the first identification information and the second identification information are performed (step S116).

The responsibility notification unit 113 transmits, to the package control server 106, a notification of responsibility including the second identification information generated in step S112 and the first identification information for identifying the package P. The first communication unit 139 acquires the notification of responsibility.

The first communication unit 139 changes the package control data 140 by the first identification information and the second identification information acquired in step S116 (step S117). Specifically, for example, the first communication unit 139 determines, in the package control data 140, the first identification information being relevant to the first identification information acquired in step S116, and sets second identification information in association with the determined first identification information.

This ends the responsibility determination processing.

### (Package Acceptance Processing)

The package reception processing is processing for the delivery person Da to receive the package P at the reception place Q. At start of the package acceptance processing, the package control terminal 105 is on standby in such a way as to be able to acquire second identification information.

When seeing display performed in step S115, and finding out that the delivery person Da has become the person in charge, the delivery person Da heads for the reception place Q in order to accept the package P. Then, in order for the delivery person Da to accept the package P at the reception place Q, the package acceptance processing is performed.

As illustrated in FIG. 19, the acceptance processing unit 125 of the delivery person terminal 102a causes the first display unit 121 to display the second identification information acquired in step S114, in response to input of the delivery person Da (step S121). Note that, when display of the second identification information in step S115 continues, the processing in step S121 may not be performed.

When a user such as an employee at the reception place Q reads the second identification information displayed on the first display unit 121 by use of the hand scanner 132, the second identification information acquisition unit 133 acquires the second identification information from the hand scanner 132 (step S122).

Note that, a method of acquiring second identification information by the second identification information acquisition unit 133 is not limited to a method using a scanner such as the hand scanner 132. For example, the second identification information acquisition unit 133 may acquire second identification information by input of the user to a non-illustrated input unit. Moreover, for example, the second identification information acquisition unit 133 may acquire second identification information by near field wireless communication such as radio frequency identifier (RFID). In this case, the package control terminal 105 may be provided with, instead of the hand scanner 132, a reader that reads information from an RF tag used for RFID.

The handover authentication unit 135 performs an inquiry to the package control server 106 via the terminal communication unit 134 as to whether the second identification information acquired in step S122 is registered in the package control data 140. Based on a response to the inquiry, the handover authentication unit 135 determines whether handover authentication has succeeded (step S123).

When the second identification information acquired in step S117 is registered in the package control data 140, the handover authentication unit 135 receives a response indicating that the second identification information is registered in the package control data 140. In contrast, when the second identification information is not registered in the package control data 140, the handover authentication unit 135 receives a response indicating that the second identification information is not registered in the package control data 140.

When it is determined that the handover authentication has failed, that is to say, when it is determined that the handover authentication has not succeeded (step S123; No), the package control terminal 105 returns to waiting for acquisition of the second identification information.

When it is determined that the handover authentication has succeeded (step S123; Yes), the handover authentication unit 135 causes the terminal display unit 136 to display that the handover authentication has succeeded (step S124).

Thereby, the user can confirm that the delivery person Da who is about to accept the package P at the reception place Q is a person in charge of delivery of the package P. After the confirmation, the user hands over the package P to the delivery person Da.

Note that, the package control terminal 105 may hold the package control data 140, and the handover authentication unit 135 may refer to the package control data 140 of the package control terminal 105, and thereby determine whether it is registered in the package control data 140.

In response to input or the like of the user indicating that the display on the terminal display unit 136 has been confirmed and the package P has been handed over to the delivery person Da, a notification of package handover is transmitted and received between the package control terminal 105 and the package control server 106 (step S125).

Specifically, for example, the terminal communication unit 134 transmits a notification of package handover including the second identification information to the package control server 106. The server communication unit 138 acquires the notification of package handover from the package control terminal 105.

The server communication unit 138 changes the package control data 140 (step S126). Specifically, for example, the server communication unit 138 sets a current time as a handover date and time in association with the second identification information included in the notification of package handover.

A notification of package handover is transmitted and received between the package control server 106 and the delivery control apparatus 101 (step S127).

Specifically, for example, the first communication unit 139 transmits a notification of package handover including second identification information to the delivery control apparatus 101. The handover notification acquisition unit 114 acquires a notification of package handover from the package control server 106.

The data control unit 108 changes the delivery data 119 (step S128). Specifically, the data control unit 108 changes status information associated with the second identification information included in the notification of package handover to “delivery in progress”.

This ends the package acceptance processing.

### (Package Reception Processing)

The package reception processing is processing for the addressee R to receive the package P from the delivery person Da at the delivery destination. At start of the package reception processing, the addressee terminal 103 is on standby in such a way as to be able to acquire a reception request.

As illustrated in FIG. 20, transmission and reception of a reception request are performed (steps S131 and S132). The reception request may include at least one of a delivery ID, first identification information, and second identification information relating to the delivery of the package P.

Specifically, for example, the handover processing unit 126 of the delivery person terminal 102a transmits, to the delivery control apparatus 101, a reception request addressed to the addressee terminal 103, in response to input of the delivery person Da. The second acquisition unit 115a acquires the reception request from the delivery person terminal 102a (step S131).

Subsequently, the second acquisition unit 115a transmits the reception request to the addressee terminal 103. The second generation unit 130 acquires the reception request from the delivery control apparatus 101 (step S132).

The second generation unit 130 captures a face image of the addressee R in response to input of the addressee R, and generates face information as second biometric information, based on the face image (step S133).

Transmission and reception of the second biometric information are performed (step S134).

Specifically, for example, the second generation unit 130 transmits the second biometric information generated in step S134 to the delivery control apparatus 101, together with at least one of the delivery ID, the first identification information, and the second identification information included in the reception request. The second acquisition unit 115a acquires, from the addressee terminal 103, the second biometric information, and at least one of the delivery ID, the first identification information, and the second identification information.

The second authentication processing unit 115b performs second authentication of the addressee R, based on the second biometric information of the addressee R acquired in step S134, and the second biometric information of the addressee R included in the addressee data 118 (step S135).

Herein, based on the addressee ID associated in the delivery data 119 with at least one of the delivery ID, the first identification information, and the second identification information included in the reception request, second biometric information the addressee R included in the addressee data 118 is able to be acquired.

When the second authentication has failed, that is to say, when the second authentication has not succeeded (step S135; No), transmission and reception of a notification of second authentication failure indicating that the second authentication of the addressee R has failed are performed between the addressee terminal 103 and the delivery control apparatus 101 (step S136).

Specifically, for example, the second authentication processing unit 115b transmits a notification of second authentication failure to the addressee terminal 103 when the second authentication has failed. The reception processing unit 131 acquires a notification of second authentication failure from the delivery control apparatus 101.

The reception processing unit 131 causes the second display unit 128 to display that the second authentication has failed (step S137).

By referring to the display on the second display unit 128, the addressee R is able to find out that the second authentication has failed, and execute the second authentication again. For example, in such a case as a failure due to a poor capturing condition of a face image, there is a possibility that authentication succeeds in the second authentication that is executed again. Thereby, a possibility that the originally correct addressee R of the package P becomes unable to receive the package P is able to be reduced. Therefore, it becomes possible to improve convenience relating to reception of the package P while making an improvement in reliability of delivery.

Moreover, transmission and reception of a notification of second authentication failure indicating that the second authentication of the addressee R has failed are performed between the delivery person terminal 102a and the delivery control apparatus 101 (step S138).

Specifically, for example, when the second authentication has failed, the second authentication processing unit 115b transmits a second notification of authentication failure to the delivery person terminal 102a. The handover processing unit 126 acquires a notification of second authentication failure from the delivery control apparatus 101.

The handover processing unit 126 causes the first display unit 121 to display that the second authentication has failed (step S139). Thereby, the delivery person Da is able to find out that the second authentication has failed. There is a possibility that the addressee R who has failed the second authentication is not a correct addressee of the package P. In this case, the delivery person Da is able to suspend handover of the package P to the addressee R. Since a possibility of erroneously handing over the package P to a person other than the correct addressee R is reduced, it becomes possible to make an improvement in reliability of delivery.

When the second authentication has succeeded (step S135; Yes), transmission and reception of a notification of second authentication success indicating that the second authentication of the addressee R has succeeded are performed between the delivery person terminal 102a and the delivery control apparatus 101, as illustrated in FIG. 21 (step S141).

Specifically, for example, when the second authentication has succeeded, the second authentication processing unit 115b transmits a notification of second authentication success to the delivery person terminal 102a. The handover processing unit 126 acquires a notification of second authentication success from the delivery control apparatus 101.

The handover processing unit 126 causes the first display unit 121 to display that the second authentication has succeeded (step S142). Thereby, the delivery person Da is able to fund out that the second authentication has succeeded. There is high possibility that the addressee R who has succeeded in the second authentication is a correct addressee of the package P. Thus, since the delivery person Da is able to hand over the package P to the correct addressee R, it becomes possible to make an improvement in reliability of delivery.

Moreover, since a relatively simple method is able to prove that the addressee R is a correct addressee of the package P, it becomes possible to improve convenience relating to reception of the package P.

Transmission and reception of a notification of delivery completion are performed (step S143). The notification of delivery completion is information indicating that delivery of the package P has been completed, and includes, for example, at least one of the first identification information, the delivery ID, and the second identification information of the package P. Specifically, for example, the handover processing unit 126 of the delivery person terminal 102a transmits a notification of delivery completion to the delivery control apparatus 101 in response to input of the delivery person Da who has completed delivery of the package P. The completion notification acquisition unit 116 acquires a notification of delivery completion from the delivery person terminal 102a.

When a notification of delivery completion is acquired in step S145, the data control unit 108 changes the delivery data 119 (step S144).

Specifically, for example, the data control unit 108 sets “delivery complete” to status information associated in the delivery data 119 with at least one of first identification information, a delivery ID, and second identification information included in the notification of delivery completion.

This ends the package reception processing.

So far, the first example embodiment according to the present invention has been described.

The present example embodiment is able to determine a delivery person and deliver the package P in response to the delivery request. Thus, the package P is able to be delivered according to convenience of the addressee R. Therefore, it becomes possible to improve convenience relating to reception of the package P.

Moreover, since first authentication is performed, a person in charge of delivering the package P is able to be certainly limited to the previously registered delivery person D. Further, since second identification information for proving that the delivery person D is a person in charge of delivery of the package P is the delivery person terminal 102, a fact that the delivery person D is a correct delivery person is able to be easily and certainly confirmed by the second identification information. Therefore, it becomes possible to make an improvement in reliability of delivery.

According to the present example embodiment, a responsibility request is transmitted to the delivery person terminal 102 of the delivery person D of whom a delivery destination is included in a support range. Thereby, a delivery person D who is relatively close to a delivery destination or a delivery person D who is relatively familiar with geography of a vicinity of a delivery destination is able to be allocated to delivery of the package P, and, therefore, a possibility that the package P is able to be quickly and certainly delivered is able to be heightened. Therefore, it becomes possible to improve convenience relating to reception of the package P, and it becomes possible to make an improvement in reliability of delivery.

According to the present example embodiment, when second identification information is acquired from the package control system 104 for controlling the package P checked at the reception place R, status information of the delivery data 118 is changed to delivery-in-progress information. Thereby, delivery status of the package P is able to be recognized in real time. Therefore, it becomes possible to improve convenience relating to reception of the package P, and it becomes make an improvement in reliability of delivery.

According to the present example embodiment, when trigger information that starts second authentication during handover of the package P to the addressee R is acquired from the delivery person terminal 102, processing for generating second biometric information being biometric information of the addressee R is executed by the addressee terminal 103.

Thereby, by performing biometric authentication (second authentication) based on the second biometric information, a fact that the addressee R is a correct addressee of the package P is able to be easily and certainly confirmed. Therefore, it becomes possible to improve convenience relating to reception of the package P, and it becomes possible to make an improvement in reliability of delivery.

According to the present example embodiment, when biometric authentication (first authentication) based on biometric information of the delivery person D responding to a responsibility request has succeeded, second identification information for proving that the delivery person D is a person in charge of delivery of the package P is acquired.

Since the first authentication is performed, a person in charge of delivering the package P is able to be certainly limited to the previously registered delivery person D. Further, since the second identification information for proving that the delivery person D is a person in charge of delivery of the package P is the delivery person terminal 102, a fact that the delivery person D is a correct delivery person is able to be easily and certainly confirmed by the second identification information. Therefore, it becomes possible to make an improvement in reliability of delivery.

According to the present example embodiment, second identification information is displayed at the reception place Q of the package P. Thereby, the package P is able to be handed over to the delivery person D after the delivery person D is the delivery person D in charge of delivery of the package P is certainly confirmed at the reception place Q. Therefore, it becomes possible to make an improvement in reliability of delivery.

According to the present example embodiment, a result of biometric authentication (second authentication) of an addressee performed according to trigger information is acquired. Thereby, a fact that the addressee R is a correct addressee of the package P is able to be easily and certainly confirmed. Therefore, it becomes possible to improve convenience relating to reception of the package P, and it becomes possible to make an improvement in reliability of delivery.

According to the present example embodiment, when second identification information is acquired at the reception place R of the package P, second identification information is transmitted to the delivery control apparatus 101. Thereby, delivery status of the package P is able to be recognized in real time. Therefore, it becomes possible to improve convenience relating to reception of the package P, and it becomes possible to make an improvement in reliability of delivery.

The present invention is not limited to the first example embodiment, and various changes may be made to the first example embodiment. An example of the change is described below.

### <Modified Example 1: Configuration of Delivery Control System>

An addressee terminal, a delivery person terminal, and a package control system included in a delivery control system 100, and a package control terminal included in the package control system may be changed in number or the like as appropriate.

For example, the number of addressee terminals 103 is not limited to one, and a plurality of addressee terminals owned by each of a plurality of addressees may be provided in a delivery control system. The number of delivery person terminals 102a and 102b is not limited to two, and one or three or more delivery person terminals each owned by one or three or more addressees may be provided in the delivery control system.

Moreover, for example, the number of package control systems is not limited to one, and a package control system of each of different business operators may be provided in the delivery control system. Further, for example, a plurality of package control terminals constituting a package control system may be provided in a reception place Q. Further, there may be a plurality of reception places that an addressee R is able to specify, and, in this case, one or a plurality of package control terminals 105 may be provided for each reception place.

### <Second Modified Example; Example of Proxy Addressee>

In the first example embodiment, the example in which a person who is able to receive the package P is only the addressee R has been described. However, for example, when a home delivery destination is a home of the addressee R, a family member, a cohabitant, or the like of the addressee R may receive on behalf of the addressee R. In the second modified example, an example of a case where, in addition to the addressee R, a proxy addressee who is permitted by the addressee R to receive the package P on behalf thereof receives the package P is described.

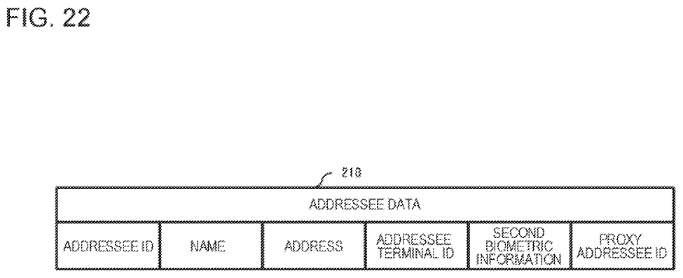

In the present modified example, instead of addressee data 118 according to the first example embodiment, addressee data 218 one example of a configuration of which is illustrated in FIG. 22 is stored in a first storage unit 107.

The addressee data 218 are data further associating a proxy addressee ID in addition to information included in the addressee data 118 according to the first example embodiment. A proxy addressee ID is information for identifying a proxy addressee. Note that, FIG. 22 illustrates one example in which the number of proxy addressee IDs is one, but a plurality of proxy addressee IDs may be associated.

The proxy addressee also owns an addressee terminal configured similarly to the addressee R. Then, information in which a proxy addressee ID is an addressee ID, and a name, an address, an addressee terminal ID, and second biometric information of the proxy addressee are associated with the addressee ID is previously set in the addressee data 218. Further, a proxy addressee ID may be associated.

A handover processing unit 126 of a delivery person terminal 102a transmits a reception request to an addressee terminal 103 of the addressee R and an addressee terminal of the proxy addressee. Then, the addressee terminal 103 of the addressee R or the proxy addressee who is able to receive the package P at a delivery destination generates second biometric information and transmits the second biometric information to the delivery control apparatus 101. Thereby, second authentication based on the second biometric information is performed, and, therefore, of the addressee R and the proxy addressee, a person owning the addressee terminal 103 that has transmitted the second biometric information is able to receive the package P. Therefore, it is possible to further improve convenience relating to reception of the package P.

<Third Modified Example: Example in which Addressee Terminal 103 Performs Second Authentication>

In the first example embodiment, an example in which second authentication is performed by a delivery control apparatus 101 has been described. However, the second authentication may be performed by an addressee terminal 103.

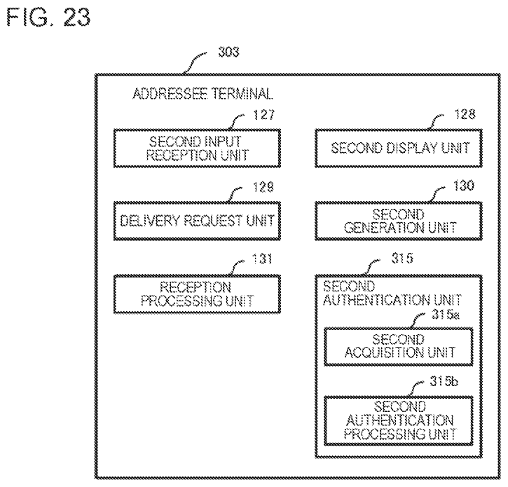

A delivery control system according to the present modified example includes an addressee terminal 303 that replaces the addressee terminal 103 according to the first example embodiment. The addressee terminal 303 functionally includes a second authentication unit 315 in addition to a functional configuration provided in the addressee terminal 103 according to the first example embodiment, as illustrated in FIG. 23.

Except for this point, the delivery control system according to the present modified example may be configured similarly to the delivery control system 100 according to the first example embodiment. Moreover, the delivery control apparatus 101 may include an information transfer unit that transfers, to an addressee apparatus 303, a reception request from a delivery person terminal 102, without including a second authentication unit 115.

The second authentication unit 315 performs second authentication, based on second biometric information generated by the second generation unit 130.

Specifically, the second authentication unit 115 performs the second authentication, based on whether second biometric information being relevant to the second biometric information generated by the second generation unit 130 is registered in the addressee data 118. The second biometric information of the addressee R registered in the addressee data 118 may be acquired by the second authentication unit 115 from the delivery control apparatus 101 via a network N.

As illustrated in FIG. 23, the second authentication unit 315 includes a second acquisition unit 315a and a second authentication processing unit 315b.

The second acquisition unit 315a acquires second biometric information generated by the second generation unit 130. The second biometric information may be similar to that according to the first example embodiment.

The second authentication processing unit 315b acquires, from the delivery control apparatus 101 via the network N, the addressee data 118 being relevant to an addressee terminal ID of the addressee terminal 303 in which the second authentication processing unit 315b is provided. The second authentication processing unit 315b compares the second biometric information acquired by the second acquisition unit 315a with the second biometric information included in the addressee data 118, and thereby performs authentication (second authentication) of the addressee R.

Note that, the second authentication processing unit 315b may previously hold the addressee data 118 being relevant to the addressee terminal ID of the addressee terminal 303 in which the second authentication processing unit 315b is provided, or second biometric information included in the addressee data 118. In this case, the second authentication processing unit 315b, the addressee data 118 may perform second authentication, based on the addressee data 118 included in the second authentication processing unit 315b.

For example, when the second biometric information acquired by the second acquisition unit 315a is a face image of the addressee R, and the second biometric information included in the addressee data 118 is a feature value, the second authentication processing unit 315b first extracts a feature value by processing a face image being the second biometric information acquired by the second acquisition unit 315a. Next, the second authentication processing unit 315b compares the extracted feature value with the feature value being the second biometric information included in the addressee data 118.

As a result of the comparison, when a difference between the feature values is within a previously determined allowable range, the second authentication processing unit 315b determines that the second authentication has succeeded. When a difference between the feature values exceeds the previously determined allowable range, the second authentication processing unit 315b determines that the second authentication has failed.

Note that, various methods may be adopted for the second authentication by the second authentication processing unit 115b, similarly to the second authentication by the second authentication processing unit 115b according to the first example embodiment.

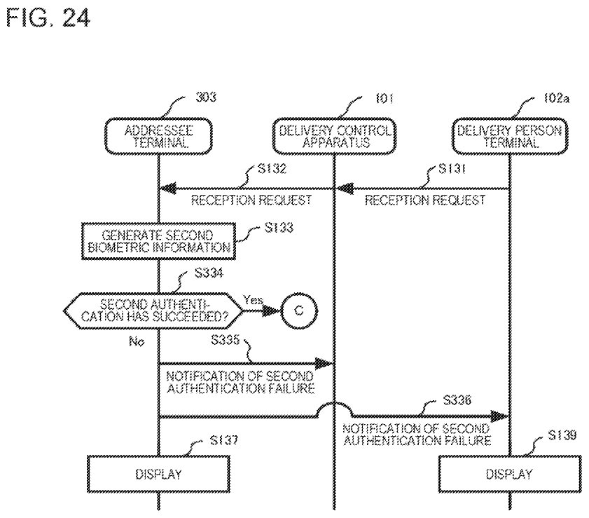

As illustrated in FIG. 24, in package reception processing according to the present modified example, processing in steps S131 to S133 is performed similarly to the first example embodiment.

When the second acquisition unit 315a generates the second biometric information generated in step S133, the second authentication processing unit 315b performs second authentication of the addressee R, based on the second biometric information, and second biometric information of the addressee R included in the addressee data 118 (step S334).

When the second authentication has failed, that is to say, when the second authentication has not succeeded (step S334; No), transmission and reception of a notification of second authentication failure indicating that the second authentication of the addressee R has failed are performed between the addressee terminal 103 and the delivery control apparatus 101 (step S335).

Specifically, for example, when the second authentication has failed, the second authentication processing unit 315b transmits a notification of second authentication failure to the delivery control apparatus 101. A handover notification acquisition unit 114 acquires a notification of second authentication failure from the addressee terminal 103.

Moreover, transmission and reception of a notification of second authentication failure indicating that the second authentication of the addressee R has failed are performed between the addressee terminal 103 and the delivery person terminal 102a (step S336).

Specifically, for example, the second authentication processing unit 315b transmits a notification of second authentication failure to the addressee terminal 103 when the second authentication has failed. The reception processing unit 131 acquires the notification of second authentication failure from the addressee terminal 103. Note that, the notification of second authentication failure may be transmitted from the addressee terminal 103 to the delivery person terminal 102a via the delivery control apparatus 101, similarly to a reception request.

Processing in steps S137 and S139 similar to that according to the first example embodiment are performed.

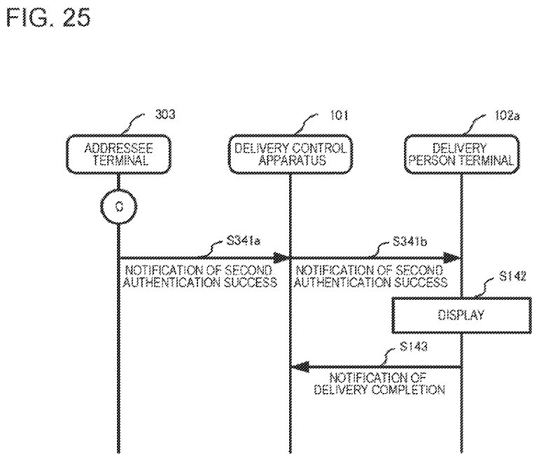

When the second authentication has succeeded (step S334; Yes), transmission and reception of a notification of second authentication success indicating are performed, as illustrated in FIG. 25 (steps S341a and 341b).

Specifically, for example, when the second authentication has succeeded, the second authentication processing unit 315b transmits the notification of second authentication success to the delivery control apparatus 101. Upon acquiring a notification of second authentication success from the addressee terminal 303, the delivery control apparatus 101 transmits the notification of second authentication success to the delivery person terminal 102a. The handover processing unit 126 acquires the notification of second authentication success from the delivery control apparatus 101.

The present modified example also has an effect similar to that according to the first example embodiment.

### <Fourth Modified Example; Another Example of Trigger Information>

In the first example embodiment, a case where a reception request is trigger information has been described as an example. However, the trigger information is not limited thereto.

For example, when an addressee R receives a package P, processing (delivery person authentication) for confirming that a delivery person Da who has delivered the package P to a delivery destination is a correct delivery person may be performed. That is to say, when the addressee R receives the package P, delivery person authentication similar to handover authentication according to the first example embodiment may be performed. Then, information indicating that delivery person authentication has succeeded may be handled as trigger information.

A delivery control system according to the present modified example includes a delivery person terminal 402 and an addressee terminal 403 that replace a delivery person terminal 102 and an addressee terminal 103 according to the first example embodiment, respectively. Except for the points, the delivery control system according to the present modified example may be configured similarly to the delivery control system 100 according to the first example embodiment.

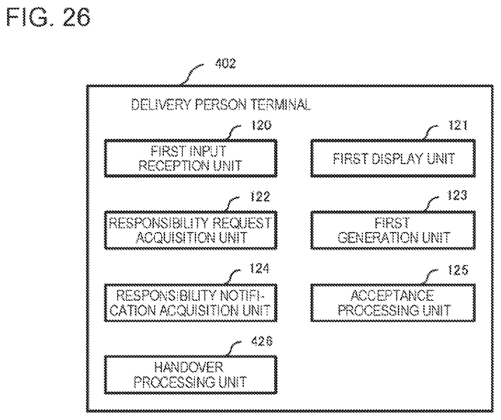

The delivery person terminal 402 functionally includes a handover processing unit 426 that replaces the handover processing unit 126 according to the first example embodiment, as illustrated in FIG. 26. Except for this point, the delivery person terminal 402 may be configured similarly to the delivery person terminal 102 according to the first example embodiment.

The handover processing unit 426 performs processing for a delivery person D to deliver the package P to the addressee R. Specifically, for example, the handover processing unit 426 causes a first display unit 121 to display second identification information relating to delivery of the package P in response to input of the delivery person D when the delivery person D hands over the package P to the addressee R. When delivery person authentication based on second identification information displayed on the first display unit 121 has succeeded, the handover processing unit 426 acquires a result of the second authentication performed according to a success of the delivery person authentication.

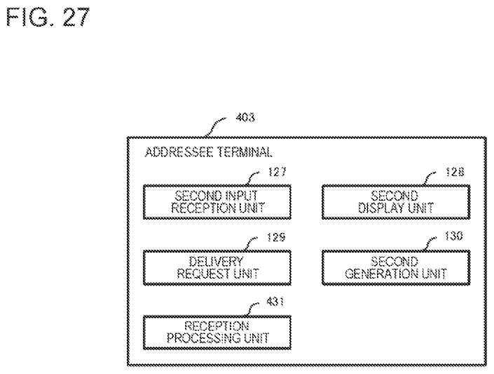

The addressee terminal 403 functionally includes a reception processing unit 431 that replaces a reception processing unit 131 according to the first example embodiment, as illustrated in FIG. 27. Except for this point, the addressee terminal 403 may be configured similarly to the addressee terminal 103 according to the first example embodiment.

The reception processing unit 431 performs processing for the addressee R to receive the package P from the delivery person D. Specifically, for example, the reception processing unit 431 acquires the second identification information by reading second identification information displayed on the first display unit 121, in response to input of the addressee R.

Upon acquiring the second identification information, the reception processing unit 431 transmits the second identification information to the delivery control apparatus 101 via the network N, and inquires whether the second identification information is registered in delivery data 119.

Note that, the delivery data 119 being relevant to the addressee ID of the addressee terminal 303 including the reception processing unit 431, or second identification information included in the delivery data 119 may be previously transmitted from the delivery control apparatus 101 to the addressee terminal 303, and held in the addressee terminal 303, for example, the reception processing unit 431 or the like. In this case, when receiving second identification information, the reception processing unit 431 may perform delivery person authentication, based on whether the second identification information is registered in the delivery data 119 previously held by the reception processing unit 431 or matches second identification information previously held by the reception processing unit 431.

Upon acquiring a response indicating that the second identification information is registered in the delivery data 119, the reception processing unit 431 determines that the delivery person authentication has succeeded. When a response indicating that the second identification information is not registered in the delivery data 119 is acquired, it is determined that the delivery person authentication has failed.

Moreover, when the delivery person authentication has succeeded, the reception processing unit 431 transmits biometric information generated by a second generation unit 130 to the delivery control apparatus 101, similarly to the reception processing unit 131 according to the first example embodiment.

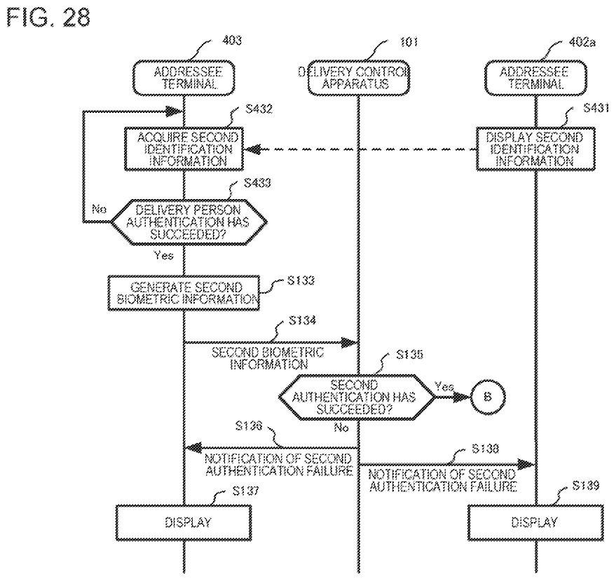

In the package reception processing according to the present modified example, as illustrated in FIG. 28, the handover processing unit 426 causes the first display unit 121 to display the second identification information in response to input by the delivery person D. Thereby, the first display unit 121 displays the second identification information (step S431).

The reception processing unit 431 acquires second identification information by reading the second identification information displayed on the first display unit 121, in response to input of the addressee R (step S432).

The reception processing unit 431 transmits second identification information to the delivery control apparatus 101 via the network N, and inquires whether the second identification information is registered in the delivery data 119.

In response to the inquiry, the data control unit 108 transmits, to the addressee terminal 403, a response including whether the second identification information acquired from the addressee terminal 403 is registered in the delivery data 119 in association with an addressee ID of the addressee R.

When determining, based on the response to the inquiry, that the delivery person authentication has failed, that is to say, the delivery person authentication has not succeeded (step S433), the reception processing unit 431 returns to wait for acquisition of second identification information.

When the reception processing unit 431 determines, based on the response to the inquiry, that the delivery person authentication has succeeded (step S433), processing in and after step S133 is performed similarly to the first example embodiment. That is to say, in the present modified example, a response indicating that delivery person authentication has succeeded serves as trigger information.

According to the present modified example, when receiving the package P, the addressee R is able to confirm that the delivery person Da who has delivered the package P to a delivery destination is a correct delivery person. Thereby, for example, when the delivery person Da is not a correct delivery person, there is a possibility that the package P is incorrect, and, therefore, the addressee R is able to take a measure such as not receiving the package P. Therefore, it becomes possible to make an improvement in reliability of delivery.

### Second Example Embodiment

In the first example embodiment, a case where a reception place Q is a convenience store, a delivery center, or the like has been described as an example. Herein, for example, when the reception place Q is a place other than a delivery center, it is desirable that a home delivery company is able to easily control status of a package P at the reception place Q, such as who has received the package P. In the present example embodiment, a delivery control system that facilitates control of a package by a home delivery company in this way is described. In the present example embodiment, a case where the reception place Q is a place other than a delivery center, for example, a convenience store, is described as an example.

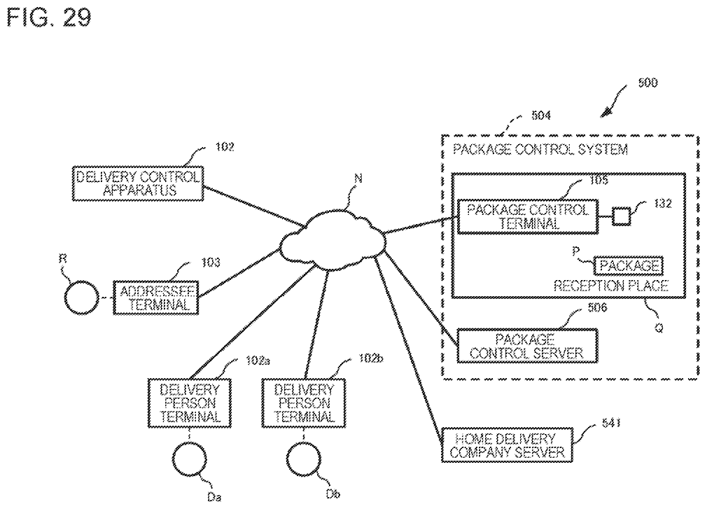

A delivery control system 500 according to the present example embodiment includes a package control system 504 that replaces the package control system 104 according to the first example embodiment, as illustrated in FIG. 29. Moreover, the delivery control system 500 further includes a home delivery company server 541. The home delivery company server 541 is connected to at least the package control server 106 via the network N in such a way as to be able to exchange information with each other. Except for the points, delivery control system 500 may be configured similarly to a delivery control system 100 according to the first example embodiment.

Note that, the number of the home delivery company servers 541 is not limited to one, and, for example, a home delivery company server of each of different home delivery companies may be provided in a delivery control system.

The package control system 504 includes a package control server 506 that replaces the package control server 106 according to the first example embodiment, as illustrated in FIG. 29. Except for this point, the package control system 504 may be configured similarly to the package control system 104 according to the first example embodiment.

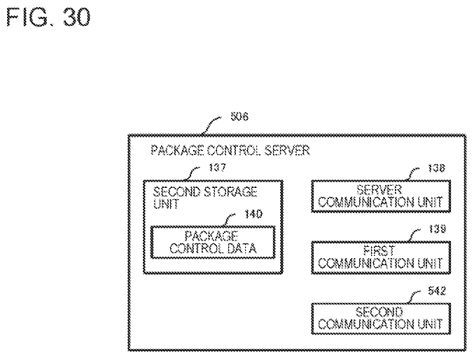

The package control server 506 functionally includes a second communication unit 542 in addition to a configuration of the package control server 106 according to the first example embodiment, as illustrated in FIG. 30. Except for this point, the package control server 506 may be configured similarly to the package control server 106 according to the first example embodiment.

The second communication unit 542 transmits and receives information to and from the home delivery company server 541 by mutually communicating with the home delivery company server 541.

Specifically, for example, when the terminal communication unit 134 acquires a notification of package handover indicating that the package P has been handed over to a delivery person Da, the second communication unit 542 transmits, to the home delivery company server 541, a notification of package delivery including second identification information. That is to say, when the second identification information is acquired by a second identification information acquisition unit 133 and the package P is handed over to the delivery person Da, the second communication unit 542 transmits the second identification information to the home delivery company server 541. Thereby, the home delivery company server 541 can control a fact that the package P has been handed over to delivery person D.

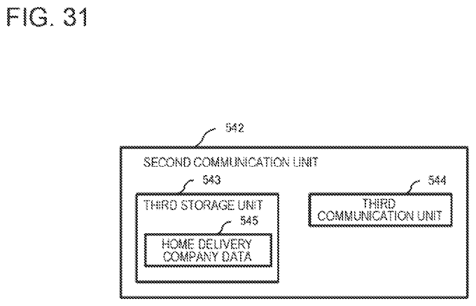

The home delivery company server 541 is an apparatus for controlling delivery of the package P by a home delivery company that has delivered the package P to the reception place Q. The home delivery company server 541 functionally includes a third storage unit 543 and a third communication unit 544, as illustrated in FIG. 31.

The third storage unit 543 is a storage unit that stores various pieces of data such as home delivery company data 545.

### (Configuration of Home Delivery Company Data 545)

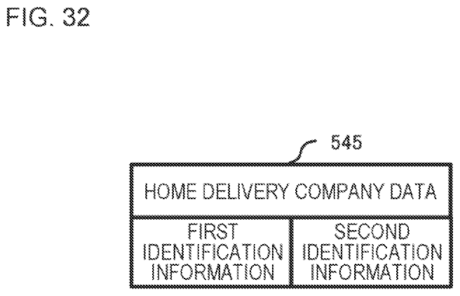

The home delivery company data 545 are data for a home delivery company to control the package P that has been kept at the reception place Q. The home delivery company data 545 are data associating first identification information and second identification information with each other, as one example of a configuration thereof is illustrated in FIG. 32.

The first identification information is information for identifying the package P at a home delivery company, and is set, for example, when a request for shipment of the package P is received. The second identification information is information, similar to that in the first example embodiment, for proving that the delivery person D is a person in charge of delivery of the package P, and is generated by the delivery control apparatus 101 when the delivery person D in charge of delivery of the package P from the reception place Q to a delivery destination is determined.

The third communication unit 544 transmits and receives information to and from the home delivery company server 541 by mutually communicating with the home delivery company server 541.

### <Physical Configuration of Delivery Control System 500>

The delivery control system 100 includes a delivery control apparatus 101, a delivery person terminal 102, an addressee terminal 103, and a package control terminal 105 being similar to those in the first example embodiment, a package control server 506, and a home delivery company server 541, that are physically connected via network N. The package control server 506 and the home delivery company server 541 may be configured similarly to the delivery control apparatus 101 according to the first example embodiment (see FIG. 13).

### <<Operation of Delivery Control System 500>>

From here, an operation of the delivery control system 500 is described with reference to the drawings. The delivery control system 500 executes delivery control processing for controlling delivery of the package P in response to a delivery request from the addressee R of the package P, similarly to the delivery control system 100 according to the first example embodiment. The delivery control processing includes delivery request processing, responsibility determination processing, and package reception processing that are similar to those according to the first example embodiment. The present example embodiment is different from the first example embodiment in package acceptance processing.

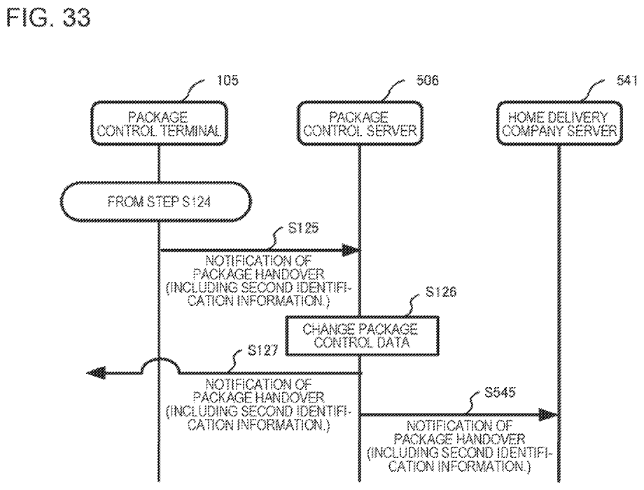

In the package acceptance processing according to the present example embodiment, as illustrated in FIG. 33, processing in step S545 is performed after processing of step S127. That is to say, in the package acceptance processing according to the present example embodiment as well, processing in steps S121 to S128 similar to those according to the first example embodiment is performed.

When processing of step S127 is performed, a notification of package acceptance is transmitted and received between the package control server 506 and the home delivery company server 541 (step S545).

Specifically, for example, the second communication unit 542 transmits, to the home delivery company server 541, a notification of package handover including first identification information and second identification information. The third communication unit 544 acquires a notification of package handover from the package control server 506.

Then, the third communication unit 544 changes the home delivery company data 545 by setting, in the home delivery company data 545, the second identification information included in the notification of package handover. In this instance, the second identification information is set in association with the first identification information of the home delivery company data 545 being relevant to the first identification information included in the notification of package handover.

According to the present example embodiment, when the package P at the reception place Q is handed over to the delivery person D, the second identification information is transmitted to each of the home delivery company server 541 and the delivery control apparatus 102. Thereby, status of the package P at the reception place Q is able to be recognized not only in the delivery control apparatus 102 but also in the home delivery company server 541. Therefore, it becomes possible to facilitate control of a package by a home delivery company that has delivered the package P to the reception place Q.

The example embodiments and the modified examples of the present invention have been described above with reference to the drawings, but are exemplifications of the present invention, and various configurations other than those described above can also be adopted.

Moreover, although a plurality of processes (pieces of processing) are described in order in a plurality of flowcharts used in the above description, an execution order of processes executed in each example embodiment is not limited to the described order. In each example embodiment, an order of illustrated processes is able to be changed to an extent that causes no problem in terms of content. Moreover, each of the example embodiments and modified examples described above can be combined to an extent that content does not contradict.

Some or all of the above-described example embodiments can also be described as, but are not limited to, the following supplementary notes.
1. A delivery control apparatus including:
   a delivery request acquisition unit that acquires, from an addressee terminal, a delivery request including first identification information for identifying a package;
   a responsibility request unit that transmits a responsibility request for delivery of the package to a delivery person terminal;
   a delivery person authentication unit that performs biometric authentication of a delivery person, based on biometric information acquired from the delivery person terminal of the delivery person who responds to the responsibility request; and a responsibility notification unit that transmits, to the delivery person terminal, second identification information for proving that the delivery person is a person in charge of delivery of the package, when the biometric authentication of the delivery person has succeeded.
2. The delivery control apparatus according to supplementary note 1, wherein
   the delivery request is information including an address of each of a reception place of the package and a delivery destination of the package.
3. The delivery control apparatus according to supplementary note 2, wherein
   a support range being a range in which the delivery person is capable of delivering is determined for the delivery person, and
   the responsibility request unit transmits the responsibility request to the delivery person terminal of the delivery person of whom support range includes the delivery destination.
4. The delivery control apparatus according to any one of supplementary notes 1 to 3, further including
   a data control unit that sets a fact that delivery is in progress as status information associated with the second identification information in delivery data, when the second identification information is acquired from a package control system for controlling the package checked at a reception place.
5. The delivery control apparatus according to any one of supplementary notes 1 to 4, further including
   an addressee authentication unit that causes the addressee terminal to execute processing for generating biometric information of an addressee when trigger information serving as a trigger for starting biometric authentication of the addressee during handover of the package to the addressee is acquired from the delivery person terminal.
6. A delivery person terminal including:
   a responsibility request acquisition unit that acquires a responsibility request for delivery of a package;
   a generation unit that generates biometric information of a delivery person who responds to the responsibility request; and
   a responsibility notification acquisition unit that acquires second identification information for proving that the delivery person is a person in charge of delivery of the package, when biometric authentication based on biometric information of the delivery person has succeeded.
7. The delivery person terminal according to supplementary note 6, further including
   a display unit that displays the second identification information as a one-dimensional code or a two-dimensional code.
8. The delivery person terminal according to supplementary note 6 or 7, further including
   a handover processing unit that transmits trigger information for starting biometric authentication of an addressee when the addressee receives the package, and acquires a result of biometric authentication of the addressee performed according to the trigger information.
9. An addressee terminal including:
   a second generation unit that generates biometric information of an addressee upon acquiring trigger information for starting biometric authentication of the addressee when the addressee receives the package; and
   a reception processing unit that executes biometric authentication of the addressee, based on the biometric information, or transmits the biometric information to a delivery control apparatus for controlling delivery of the package.
10. The addressee terminal according to supplementary note 9, wherein,
   when biometric authentication of the addressee is executed based on the biometric information, the reception processing unit transmits a result of the biometric authentication to a delivery person terminal or the delivery control apparatus.
11. A package control system including a package control terminal installed at a reception place of a package, the package control system including:
   a second identification information acquisition unit that acquires, from a delivery person terminal, second identification information for proving that a delivery person is a person in charge of delivery of the package; and
   a first communication unit that mutually communicates with a delivery control apparatus for controlling delivery of the package, wherein
   the first communication unit transmits the second identification information to the delivery control apparatus when the second identification information is acquired by the second identification information acquisition unit.
12. The package control system according to supplementary note 11, further including
   a second communication unit that mutually communicates with a home delivery company server for controlling delivery of the package at a home delivery company that has delivered the package to the reception place, wherein
   the second communication unit transmits the second identification information to the home delivery company server when the second identification information is acquired by the second identification information acquisition unit.
13. A delivery control system including:
   an addressee terminal owned by an addressee of a package delivered to a reception place;
   a delivery control apparatus for controlling delivery of the package in response to a delivery request from the addressee; and
   a delivery person terminal owned by a delivery person of the package, wherein
   the addressee terminal includes
      a delivery request unit that transmits a delivery request including first identification information for identifying the package,
   the delivery control apparatus includes
      a delivery request acquisition unit that acquires the delivery request from the addressee terminal,
      a responsibility request unit that transmits a responsibility request for delivery of the package to the delivery person terminal,
      a delivery person authentication unit that performs biometric authentication of a delivery person, based on biometric information of the delivery person acquired from the delivery person terminal of the delivery person who responds to the responsibility request, and
      a responsibility notification unit that transmits, to the delivery person terminal, second identification information for proving that the delivery person is a person in charge of delivery of the package, when biometric authentication of the delivery person has succeeded, and
   the delivery person terminal includes
      a responsibility request acquisition unit that acquires the responsibility request,
      a generation unit that generates biometric information of the delivery person who responds to the responsibility request, and
      a responsibility notification acquisition unit that acquires the second identification information from the delivery control apparatus, when biometric authentication of the delivery person has succeeded.
14. A delivery control method including,
   by a computer:
   acquiring, from an addressee terminal, a delivery request including first identification information for identifying a package;
   transmitting a responsibility request for delivery of the package to a delivery person terminal;
   performing biometric authentication of a delivery person, based on biometric information acquired from the delivery person terminal of the delivery person who responds to the responsibility request; and
   transmitting, to the delivery person terminal, second identification information for proving that the delivery person is a person in charge of delivery of the package, when the biometric authentication of the delivery person has succeeded.
15. A responsibility determination method including,
   by a computer:
   acquiring a responsibility request for delivery of a package;
   generating biometric information of a delivery person who responds to the responsibility request; and
   acquiring second identification information for proving that the delivery person is a person in charge of delivery of the package, when biometric authentication based on biometric information of the delivery person has succeeded.
16. A package reception method including,
   by a computer:
   generating biometric information of an addressee upon acquiring trigger information for starting biometric authentication of the addressee when the addressee receives a package; and
   executing biometric authentication of the addressee, based on the biometric information, or transmitting the biometric information to a delivery control apparatus for controlling delivery of the package.
17. A package control method including,
   by a computer:
   acquiring, from a delivery person terminal, second identification information for proving that a delivery person is a person in charge of delivery of the package; and
   mutually communicating with a delivery control apparatus for controlling delivery of the package, wherein
   in the communicating, the second identification information is transmitted to the delivery control apparatus when the second identification information is acquired.
18. A program for causing a computer to execute the method according to any one of supplementary notes 14 to 17.

### REFERENCE SIGNS LIST

100, 500 Delivery control system
101 Delivery control apparatus
102, 102a, 102b, 402 Delivery person terminal
103, 303, 403 Addressee terminal
104, 504 Package control system
105 Package control terminal
106, 506 Package control server
107 First storage unit
108 Data control unit
109 Delivery request acquisition unit
110 Responsibility request unit
110a Extraction unit
110b Responsibility request transmission unit
111 First authentication unit
111a First acquisition unit
111b First authentication processing unit *
112 Identification information generation unit
113 Responsibility notification unit
114 Handover notification acquisition unit
115, 315 Second authentication unit
115a, 315a Second acquisition unit
115b, 315b Second authentication processing unit
116 Completion notification acquisition unit
117 Delivery person data
118, 218 Addressee data
119 Delivery data
120 First input reception unit
121 First display unit
122 Responsibility request acquisition unit
123 First generation unit
124 Responsibility notification acquisition unit
125 Acceptance processing unit
126, 426 Handover processing unit
127 Second input reception unit
128 Second display unit
129 Delivery request unit
130 Second generation unit
131, 431 Reception processing unit
132 Hand scanner
133 Second identification information acquisition unit
134 Terminal communication unit
135 Handover authentication unit
136 Terminal display unit
137 Second storage unit
138 Server communication unit
139 First communication unit
140 Package control data
541 Home delivery company server
542 Second communication unit
543 Third storage unit
544 Third communication unit
545 Home delivery company data

What is claimed is:

1. A delivery control apparatus comprising:
at least one memory configured to store instructions; and
at least one processor configured to execute the instructions to perform operations comprising:
acquiring from an addressee terminal, a delivery request including first identification information for identifying a package;
transmitting a responsibility request for delivery of the package to a delivery person terminal;
performing biometric authentication of a delivery person, based on biometric information acquired from the delivery person terminal of the delivery person who responds to the responsibility request; and
transmitting, to the delivery person terminal, second identification information for proving that the delivery person is a person in charge of delivery of the package, when the biometric authentication of the delivery person has succeeded.

2. The delivery control apparatus according to claim 1, wherein
the delivery request is information including an address of each of a reception place of the package and a delivery destination of the package.

3. The delivery control apparatus according to claim 2, wherein
a support range being a range in which the delivery person is capable of delivering is determined for the delivery person, and
the responsibility request is transmitted to the delivery person terminal of the delivery person of whom support range includes the delivery destination.

4. The delivery control apparatus according to claim 1, further comprising
setting a fact that delivery is in progress as status information associated with the second identification information in delivery data, when the second identification information is acquired from a package control system for controlling the package checked at a reception place.

5. The delivery control apparatus according to claim 1, further comprising
causing the addressee terminal to execute processing for generating biometric information of an addressee when trigger information serving as a trigger for starting biometric authentication of the addressee during handover of the package to the addressee is acquired from the delivery person terminal.

6. A delivery person terminal comprising:
at least one memory configured to store instructions; and
at least one processor configured to execute the instructions to perform operations comprising:
acquiring a responsibility request for delivery of a package;
generating biometric information of a delivery person who responds to the responsibility request; and
acquiring second identification information for proving that the delivery person is a person in charge of delivery of the package, when biometric authentication based on biometric information of the delivery person has succeeded.

7. The delivery person terminal according to claim 6, further comprising
displaying the second identification information as a one-dimensional code or a two-dimensional code.

8. The delivery person terminal according to claim 6, further comprising
transmitting trigger information for starting biometric authentication of an addressee when the addressee receives the package, and acquires a result of biometric authentication of the addressee performed according to the trigger information.

9. An addressee terminal comprising:
at least one memory configured to store instructions; and
at least one processor configured to execute the instructions to perform operations comprising:
generating biometric information of an addressee upon acquiring trigger information for starting biometric authentication of the addressee when the addressee receives a package; and
executing biometric authentication of the addressee, based on the biometric information, or transmits the biometric information to a delivery control apparatus for controlling delivery of the package.

10. The addressee terminal according to claim 9, wherein,
when biometric authentication of the addressee is executed based on the biometric information, a result of the biometric authentication to a delivery person terminal or the delivery control apparatus.

11-18. (canceled)
